(19) United States
(12) Patent Application Publication
(10) Pub. No.: US 2025/0199971 A1
(43) Pub. Date: Jun. 19, 2025

(54) DEVICE AND METHOD FOR PROCESSING DATA UNITS

(71) Applicant: Robert Bosch GmbH, Stuttgart (DE)

(72) Inventors: Herbert Leuwer, Langballig (DE); Michael Buchalik, Breisach (DE)

(21) Appl. No.: 18/847,400

(22) PCT Filed: Mar. 31, 2023
(86) PCT No.: PCT/EP2023/058519

§ 371 Date: Sep. 16, 2024

(30) Foreign Application Priority Data
Apr. 1, 2022 (DE) 10 2022 203 281.0

(51) Int. Cl. G06F 13/20

(52) U.S. Cl. CPC G06F 13/20

(57) ABSTRACT

A device for processing protocol data units. The device includes a first number of input interfaces for receiving protocol data units and, optionally, a second number of output interfaces for outputting protocol data units, and a checking apparatus that is designed to check at least one received protocol data unit, wherein the checking apparatus is designed to at least occasionally carry out at least one of the following checks: a) a non-state-based check, b) a state-based check.

### FIELD

The present invention relates to a device for processing data units.

The present invention further relates to a method for processing data units.

### SUMMARY

Exemplary embodiments of the present invention relate to a device for processing data units, for example protocol data units, having a first number of input interfaces for receiving protocol data units and, optionally, a second number of output interfaces for outputting protocol data units, and to a checking apparatus, for example a firewall apparatus, that is designed to check at least one received protocol data unit, for example to subject it to a security check, wherein the checking apparatus is designed to at least occasionally carry out at least one of the following checks: a) a non-state-based, for example non-state-oriented, for example stateless, check, for example with respect to the at least one received protocol data unit, b) a state-based, for example state-oriented, for example stateful, check, for example with respect to the at least one received protocol data unit. This allows increased flexibility with regard to checking in further exemplary embodiments.

In further exemplary embodiments of the present invention, the first number is greater than or equal to one. In further exemplary embodiments, the second number is greater than or equal to one.

In further exemplary embodiments of the present invention, the checking apparatus is designed as a hardware circuit, for example a pure hardware circuit. This allows efficient hardware-based checking, for example according to predeterminable (and/or learnable) firewall rules or security rules, for example with regard to protocol data units that can potentially be processed by the device. In addition, software-based attacks on the hardware checking apparatus or hardware firewall are ineffective.

In further exemplary embodiments of the present invention, the checking apparatus is designed to selectively check the at least one received protocol data unit, for example on the basis of a first item of control information, for example a bit flag. In other words, the checking apparatus can e.g. check intermittently received protocol data units, for example on the basis of the item of control information, which can be provided e.g. by another component of the device, and the checking apparatus intermittently does not carry out any checking of protocol data units, for example. In further exemplary embodiments, a control can be carried out as to whether e.g. a specific protocol data unit, e.g. a protocol data unit corresponding to at least one predeterminable criterion, is to be checked, e.g. by the device or another component of the device (as the checking apparatus). Alternatively or additionally, a control as to whether e.g. a specific protocol data unit is to be checked can be carried out by the checking apparatus.

In further exemplary embodiments of the present invention, the checking apparatus is designed to check at least some received protocol data units, for example all the received protocol data units.

In further exemplary embodiments of the present invention, the checking apparatus is designed to subject at least some received protocol data units to the non-state-based check and, for example on the basis of a result of the non-state-based check, to subject at least some of the received protocol data units to the state-based check.

In further exemplary embodiments of the present invention, the checking apparatus is designed to check protocol data units that are associated with at least one protocol, for example at least one service-oriented protocol, that operates on layer 5 of the ISO/OSI reference model, for example protocol data units that are associated with a Scalable Service-Oriented Middleware over IP, SOME/IP, protocol.

In further exemplary embodiments of the present invention, it is also possible to check protocol data units associated with at least one other protocol and/or other types of protocol data units, e.g. L-PDUs, l-PDUs, N-PDUs, S-PDUs.

In further exemplary embodiments of the present invention, the checking apparatus is designed to check at least one of the following elements, for example of header data, for example of a protocol data unit associated with the SOME/IP protocol, during the check, for example during the non-state-based check: a) a message identifier, for example message ID, for example in relation to at least one predeterminable valid message identifier or message ID, wherein the at least one predeterminable valid message identifier can be organized, for example, in the form of a table, wherein, for example, checking the message ID comprises ascertaining whether the message ID is a predeterminable valid message ID, b) a service identifier, for example service ID (wherein, for example, checking the service ID comprises ascertaining whether the service ID is a predeterminable valid service ID), c) a method ID (wherein, for example, checking the method ID comprises ascertaining whether the method ID is a predeterminable valid method ID), d) a length, for example in relation to a predeterminable length (wherein, for example, checking the length comprises ascertaining whether the length corresponds, for example, to the predeterminable (e.g. valid) length), e) a request identifier, for example request ID, for example in relation to a predeterminable value (wherein, for example, checking the request ID comprises ascertaining whether the request ID is a predeterminable valid request ID), f) a client identifier, for example client ID (wherein, for example, checking the client ID comprises ascertaining whether the client ID is a predeterminable valid client ID), g) a session identifier, for example session ID (wherein, for example, checking the session ID comprises ascertaining whether the session ID is a predeterminable valid session ID), h) a protocol version (for example by ascertaining whether the protocol version corresponds to a predeterminable valid protocol version), i) an interface version (for example by ascertaining whether the interface version corresponds to a predeterminable valid interface version), j) a type, for example message type (for example by ascertaining whether the message type corresponds to a predeterminable valid message type), j) a return value, for example return code (for example by ascertaining whether the return code corresponds to a predeterminable valid return code).

In further exemplary embodiments of the present invention, the checking apparatus is designed to check, for example in the state-based check, whether a) a response message has been received after the sending of a request message, for example associated with the response message, and/or whether b) a received response message is associated with a previously sent request message, and/or whether c) a received response message has been received within a predeterminable response time in relation to the sending of a request message associated with the response message.

In further exemplary embodiments of the present invention, the checking apparatus is designed to ascertain a message type of at least one SOME/IP message that is associated with the at least one received protocol data unit, wherein, for example, the message type comprises at least one of the following elements: a) REQUEST, b) REQUEST_NO_RETURN, C) NOTIFICATION, d) RESPONSE, e) ERROR, f) TP_REQUEST, g) TP_REQUEST_NO_RETURN, h) TP_NOTIFICATION, i) TP_RESPONSE, j) TP_ERROR.

In further exemplary embodiments of the present invention, the checking apparatus is designed to ascertain a service type of at least one SOME/IP message that is associated with the at least one received protocol data unit, wherein, for example, the service type comprises at least one of the following elements: a) RPC, remote procedure call, b) Fire & Forget, c) Notify.

In further exemplary embodiments of the present invention, the checking apparatus is designed to carry out a state-based and/or state-oriented evaluation of at least one SOME/IP service, for example of remote procedure calls, for example comprising request elements and/or response elements, for example on the basis of the at least one received protocol data unit.

In further exemplary embodiments of the present invention, the checking apparatus is designed to at least occasionally also carry out non-state-based and/or non-state-oriented evaluations, e.g. of SOME/IP services.

In further exemplary embodiments of the present invention, the checking apparatus is designed to discard the at least one received protocol data unit or not to discard it, for example to leave it unchanged, e.g. on the basis of the check, for example if a result of the check indicates an attempted attack or a malicious data unit.

In further exemplary embodiments of the present invention, the checking apparatus is designed not to discard the at least one received protocol data unit, for example to forward it, for example for output, e.g. to another unit, e.g. on the basis of the check, for example if a result of the check does not indicate an attempted attack or a malicious data unit.

In further exemplary embodiments of the present invention, the checking apparatus is designed to modify or influence the at least one received protocol data unit and/or an output of the at least one received protocol data unit, for example via an output interface, for example in order to effect a unicast output or a multicast output.

In further exemplary embodiments of the present invention, the checking apparatus is designed to carry out at least one of the following elements: a) attack detection, e.g. intrusion detection, and/or attack detection and attack prevention, e.g. intrusion detection and prevention, b) marking the at least one received protocol data unit, for example on the basis of the check and/or on the basis of a result of the check, c) outputting and/or forwarding the at least one received protocol data unit, for example by means of a multicast mechanism, for example to at least one software component, for example for, e.g. further, evaluation or execution of, e.g. software-based, attack detection, d) outputting and/or forwarding the at least one received protocol data unit, for example by means of a unicast mechanism, for example to at least one software component or the at least one software component, for example for, e.g. further, evaluation or execution of, e.g. software-based, attack detection, e) ascertaining and/or evaluating messages for service discovery, for example service discovery messages, which are for example based on a network protocol, e.g. a connectionless network protocol, for example on a user datagram protocol, UDP, f) ascertaining and/or evaluating protocol data units of the AUTOSAR l-PDU type, for example for a check, for example security check.

In further exemplary embodiments of the present invention, the device has a processing apparatus that is designed to perform a search in at least one first search tree on the basis of a PDU identifier associated with a received protocol data unit, which search tree has an assignment of one PDU identifier to a connection identifier characterizing at least one data connection, wherein, for example, the search can be performed before and/or after and/or at least partially simultaneously with the check. In further exemplary embodiments, the search can be used, for example, for routing, e.g. forwarding, the data unit.

In further exemplary embodiments of the present invention, for example, if the check is carried out before the search, the search can be performed e.g. on the basis of a result of the check.

In further exemplary embodiments of the present invention, for example, if the check is carried out after the search, the check can be performed e.g. on the basis of a result of the search, for example on the basis of the connection identifier, and/or on the basis of information associated with the connection identifier. In further exemplary embodiments, it can thus be achieved, for example, that a check of the relevant data units is performed by means of the checking apparatus for specific connection identifiers, whereas no check of the relevant data units is performed by means of the checking apparatus for other connection identifiers, for example.

In further exemplary embodiments of the present invention, the device is designed to ascertain a connection identifier associated with the received protocol data unit on the basis of the received protocol data unit, wherein, for example, the ascertainment can be performed before and/or after and/or at least partially simultaneously with the check.

In further exemplary embodiments of the present invention, the processing apparatus has at least one hardware component, which is designed to perform the search in the first search tree and/or to ascertain the connection identifier associated with the received protocol data unit. The hardware-based search can e.g. be carried out particularly quickly and efficiently and, like a hardware-based (firewall) check of data units, is insensitive to software-based attempted attacks.

In further exemplary embodiments of the present invention, the first search tree is a binary tree.

In further exemplary embodiments of the present invention, the processing apparatus has at least one software component, wherein the software component is designed to perform at least one of the following elements: a) at least temporarily forming the first search tree, b) at least temporarily modifying, for example balancing, the first search tree, c) receiving the at least one protocol data unit from the checking apparatus (e.g. if it is concluded on the basis of the result of the check of the protocol data unit by the checking apparatus that a, for example further, software-based check of the protocol data unit should be carried out), d) evaluating, for example performing, e.g. software-based, attack detection.

In further exemplary embodiments of the present invention, the at least one software component is designed to perform a predeterminable response if no connection identifier associated with the received protocol data unit can be ascertained for the received protocol data unit, for example if no connection identifier associated with the received protocol data unit is present for the received protocol data unit in the first search tree, wherein, for example, the predeterminable response has at least one of the following elements: a) discarding the received protocol data unit, b) assigning a connection identifier, for example a configurable connection identifier, to the received protocol data unit, c) setting or inserting a first item of information or first item of control information for the received protocol data unit, for example in the form of a bit flag, wherein the first item of information and/or the first item of control information indicates, for example, that the received protocol data unit is to be subjected to a check, for example by means of the checking apparatus, for example firewall apparatus.

In further exemplary embodiments of the present invention, the checking apparatus is designed to evaluate the first item of information and/or the first item of control information and, on the basis thereof, to perform or not perform a check of the data unit in question.

In further exemplary embodiments of the present invention, the device has at least one memory for at least temporarily storing one or more protocol data units or parts of one or more protocol data units.

In further exemplary embodiments of the present invention, the device has a conditioning apparatus, which is designed to change, for example normalize, a PDU identifier associated with a received protocol data unit.

In further exemplary embodiments of the present invention, a data structure, for example a node structure, for the at least one search tree has an attribute that indicates whether a security check is to be performed, for example by means of the checking apparatus, for a relevant protocol data unit or for protocol data units associated with a connection identifier. For example, the attribute can correspond to the first item of information or first item of control information.

In further exemplary embodiments of the present invention, the checking apparatus is designed to use a or the connection identifier associated with a received protocol data unit, for example for ascertaining a service associated with e.g. the at least one received protocol data unit and/or an identifier.

Further exemplary embodiments of the present invention relate to a method, for example a computer-implemented method, for processing data units, for example protocol data units, for a device, for example according to at least one of the above-described embodiments, having a first number of input interfaces for receiving protocol data units and, optionally, a second number of output interfaces for outputting protocol data units, and a checking apparatus, for example a firewall apparatus, that is designed to check at least one received protocol data unit, for example to subject it to a security check, the method comprising: receiving at least one protocol data unit, checking the received at least one protocol data unit by means of the checking apparatus, wherein the checking apparatus at least occasionally carries out at least one of the following checks: a) a non-state-based, for example non-state-oriented, for example stateless, check, for example with respect to the at least one received protocol data unit, b) a state-based, for example state-oriented, for example stateful, check, for example with respect to the at least one received protocol data unit.

In further exemplary embodiments of the present invention, the method comprises at least one of the following elements: a) outputting the at least one protocol data unit, for example on the basis of the check, b) discarding the at least one protocol data unit, for example on the basis of the check.

In further exemplary embodiments of the present invention, the checking apparatus subjects at least some received protocol data units to the non-state-based check and, for example on the basis of a result of the non-state-based check, subjects at least some of the received protocol data units to the state-based check.

In further exemplary embodiments of the present invention, the checking apparatus modifies or influences the at least one received protocol data unit and/or an output of the at least one received protocol data unit, for example via an output interface.

In further exemplary embodiments of the present invention, the checking apparatus carries out at least one of the following elements: a) attack detection, e.g. intrusion detection, b) marking the at least one received protocol data unit, for example on the basis of the check and/or on the basis of a result of the check, c) outputting and/or forwarding the at least one received protocol data unit, for example by means of a multicast mechanism, for example to at least one software component, for example for, e.g. further, evaluation or execution of, e.g. software-based, attack detection, d) outputting and/or forwarding the at least one received protocol data unit, for example by means of a unicast mechanism, for example to at least one software component or the at least one software component, for example for, e.g. further, evaluation or execution of, e.g. software-based, attack detection, e) ascertaining and/or evaluating messages for service discovery, for example service discovery messages, which are for example based on a network protocol, e.g. a connectionless network protocol, for example on a user datagram protocol, UDP, f) ascertaining and/or evaluating protocol data units of the AUTOSAR l-PDU type, for example for a check, for example security check.

In further exemplary embodiments of the present invention, the method comprises at least one of the following elements: a) receiving data, for example in the form of a data frame, b) ascertaining an endpoint associated with the reception of the data, for example an input interface associated with the reception of the data, for example a socket, for example a user datagram protocol, UDP, socket, for example by means of a ternary content addressable memory, TCAM, (or e.g. by means of a tree structure, e.g. search tree), c) breaking down, e.g. decomposing, the data frame into at least one protocol data unit, for example S-PDU, d) assigning an identifier characterizing the endpoint to the at least one protocol data unit, e) checking, for example by means of the device or the checking apparatus, at least one of the following elements of the at least one protocol data unit, for example S-PDU: e1) message identifier, for example message ID, e2) request identifier, for example request ID, e3) protocol version, e4) interface version, e5) type, for example message type, f) on the basis of the check, f1) outputting or forwarding the data, for example in the form of the data frame or f2a) discarding the data, for example the data frame and/or f2b) incrementing a counter.

In further exemplary embodiments of the present invention, the method comprises at least one of the following elements: a) receiving data, for example in the form of a data frame, b) ascertaining an endpoint associated with the reception of the data, for example an input interface associated with the reception of the data, for example a socket, for example a controller area network, CAN, socket, for example by means of a ternary content addressable memory, TCAM, c) breaking down the data frame into at least one protocol data unit, for example l-PDU, d) assigning an identifier characterizing the endpoint to the at least one protocol data unit, e) checking, for example by means of the device or the checking apparatus, at least one of the following elements of the at least one protocol data unit, for example l-PDU: e1) message identifier, for example message ID, e2) length, f) on the basis of the check, f1) outputting or forwarding the data, for example in the form of the data frame or f2a) discarding the data, for example the data frame and/or f2b) incrementing a counter.

Further exemplary embodiments of the present invention relate to a device for performing the method according to the embodiments.

Further exemplary embodiments of the present invention relate to a computer-readable storage medium comprising instructions that, when executed by a computer, cause the computer to perform at least some steps of the method according to the embodiments.

Further exemplary embodiments of the present invention relate to a computer program comprising instructions that, when the program is executed by a computer, cause the computer to perform at least some steps of the method according to the embodiments.

Further exemplary embodiments of the present invention relate to a data carrier signal that transmits and/or characterizes the computer program according to the embodiments.

Further exemplary embodiments of the present invention relate to a gateway, for example an automotive gateway, comprising at least one device according to the embodiments.

Further exemplary embodiments of the present invention relate to the use of the device according to the embodiments and/or of the method according to the embodiments and/or of the computer-readable storage medium according to the embodiments and/or of the computer program according to the embodiments and/or of the data carrier signal according to the embodiments and/or of the gateway according to the embodiments for at least one of the following elements: a) processing data units, for example protocol data units, for example of a vehicle, for example of a motor vehicle, b) ascertaining, for example searching for, for example by means of a hardware component, a connection identifier associated with a received protocol data unit, c) managing at least one search tree, d) performing a hardware-based search for a connection identifier for a data unit, for example a protocol data unit, for example of a gateway for automotive applications, wherein, for example, the search can be performed with logarithmic effort, e) routing or relaying data units, for example protocol data units, for example of a vehicle, for example of a motor vehicle, wherein, for example, the data units can be of different types, f) assigning a connection identifier, for example a protocol-independent connection identifier, g) performing multicast transmissions, h) ascertaining whether no connection identifier is provided, for example stored, for example contained in the search tree, for a predeterminable received data unit, for example a protocol data unit, i) software-based processing of a received data unit, for example a protocol data unit, for which no connection identifier is provided, for example stored, for example contained in the search tree, j) checking the at least one received protocol data unit, for example performing a security check, k) hardware-based firewall check of protocol data unit that are associated with at least one protocol, for example at least one service-oriented protocol that runs on layer 5 of the ISO/OSI reference model, for example protocol data units that are associated with a Scalable Service-Oriented Middleware over IP, SOME/IP, protocol, l) selectively applying routing functions, for example forwarding functions, and/or firewall functions to protocol data units.

Further features, possible applications and advantages of the present invention will be apparent from the following description of exemplary embodiments of the present invention shown in the figures of the drawings. In this case, all of the features described or shown form the subject matter of the present invention individually or in any combination, irrespective of their wording or representation in the description or in the figures.

### BRIEF DESCRIPTION OF THE DRAWINGS

FIG. 1 schematically shows a simplified block diagram according to exemplary embodiments of the present invention.

FIG. 2A schematically shows a simplified flow diagram according to exemplary embodiments of the present invention.

FIG. 2B schematically shows a simplified flow diagram according to exemplary embodiments of the present invention.

FIG. 2C schematically shows a simplified block diagram according to exemplary embodiments of the present invention.

FIG. 2D schematically shows a simplified flow diagram according to exemplary embodiments of the present invention.

FIG. 3 schematically shows a simplified flow diagram according to exemplary embodiments of the present invention.

FIG. 4 schematically shows a simplified flow diagram according to exemplary embodiments of the present invention.

FIG. 5 schematically shows a simplified flow diagram according to exemplary embodiments of the present invention.

FIG. 6 schematically shows a simplified block diagram according to exemplary embodiments of the present invention.

FIG. 7 schematically shows a simplified block diagram according to exemplary embodiments of the present invention.

FIG. 8 schematically shows a simplified block diagram according to exemplary embodiments of the present invention.

FIG. 9 schematically shows a simplified flow diagram according to exemplary embodiments of the present invention.

FIG. 10 schematically shows a simplified flow diagram according to exemplary embodiments of the present invention.

FIG. 11 schematically shows a simplified flow diagram according to exemplary embodiments of the present invention.

FIG. 12 schematically shows a simplified flow diagram according to exemplary embodiments of the present invention.

FIG. 13 schematically shows a simplified flow diagram according to exemplary embodiments of the present invention.

FIG. 14 schematically shows a simplified flow diagram according to exemplary embodiments of the present invention.

FIG. 15 schematically shows a simplified block diagram according to exemplary embodiments of the present invention.

FIG. 16 schematically shows a simplified flow diagram according to exemplary embodiments of the present invention.

FIG. 17 schematically shows a simplified flow diagram according to exemplary embodiments of the present invention.

FIG. 18 schematically shows a simplified block diagram according to exemplary embodiments of the present invention.

FIG. 19 schematically shows a simplified block diagram according to exemplary embodiments of the present invention.

FIG. 20 schematically shows a simplified flow diagram according to exemplary embodiments of the present invention.

FIG. 21 schematically shows a simplified block diagram according to exemplary embodiments of the present invention.

FIG. 22 schematically shows a simplified block diagram according to exemplary embodiments of the present invention.

FIG. 23 schematically shows aspects of uses according to exemplary embodiments of the present invention.

FIG. 24A schematically shows a simplified flow diagram according to exemplary embodiments of the present invention.

FIG. 24B schematically shows a simplified flow diagram according to exemplary embodiments of the present invention.

FIG. 25A schematically shows a simplified flow diagram according to exemplary embodiments of the present invention.

FIG. 25B schematically shows a simplified flow diagram according to exemplary embodiments of the present invention.

FIG. 26 schematically shows a simplified block diagram according to exemplary embodiments of the present invention.

FIG. 27 schematically shows a simplified signal diagram according to exemplary embodiments of the present invention.

### DETAILED DESCRIPTION OF EXAMPLE EMBODIMENTS

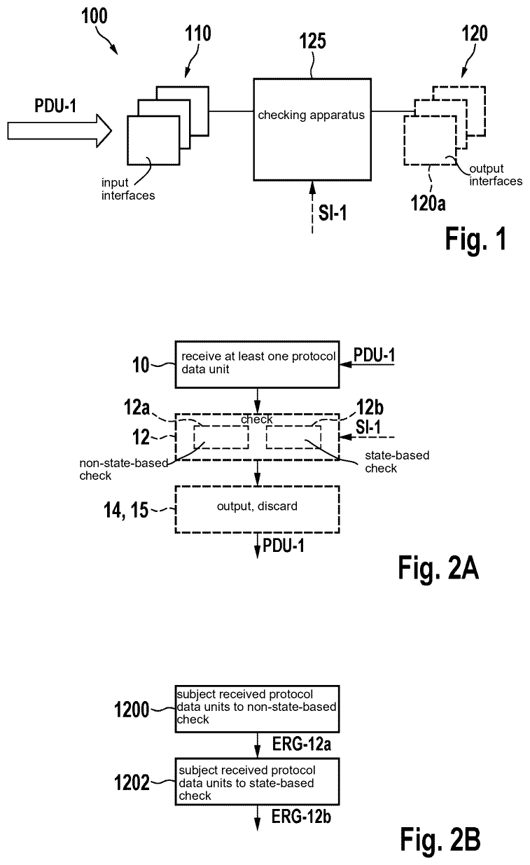

Exemplary embodiments, FIG. 1, relate to a device 100 for processing data units PDU-1, for example protocol data units, having a first number of input interfaces 110 for receiving protocol data units PDU-1 and, optionally, a second number of output interfaces 120 for outputting protocol data units, and a checking apparatus 125, for example a firewall apparatus (hereinafter referred to as “firewall” for short), that is designed to check at least one received protocol data unit PDU-1, for example to subject it to a security check, wherein the checking apparatus 125 is designed to at least occasionally carry out at least one of the following checks: a) a non-state-based, for example non-state-oriented, for example stateless, check, for example with respect to the at least one received protocol data unit PDU-1, b) a state-based, for example state-oriented, for example stateful, check, for example with respect to the at least one received protocol data unit PDU-1. This allows increased flexibility with regard to checking in further exemplary embodiments.

In further exemplary embodiments, the first number is greater than or equal to one. In further exemplary embodiments, the second number is greater than or equal to one.

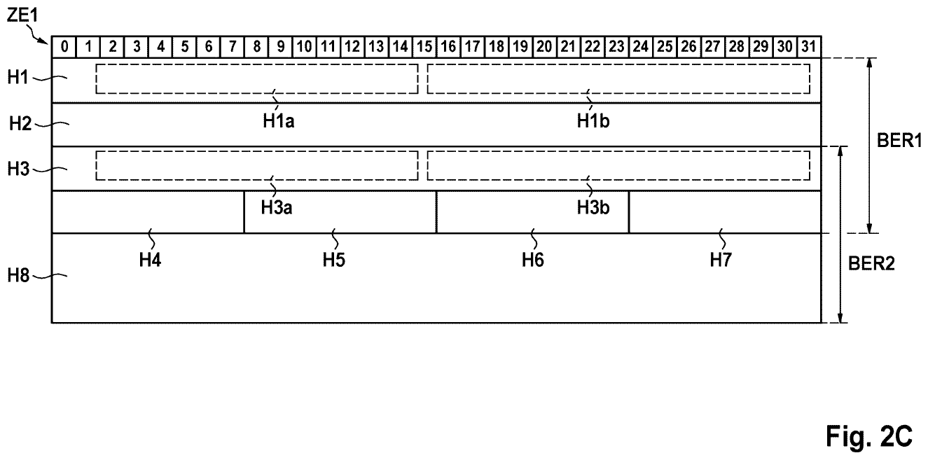

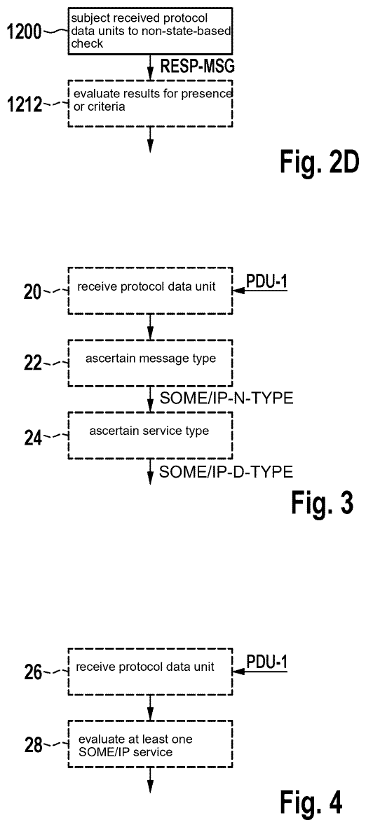

A flow diagram of a corresponding method according to exemplary embodiments is shown in FIG. 2A, wherein block 10 symbolizes the receiving of the at least one protocol data unit PDU-1, and wherein block 12 symbolizes an optional check. Block 12a symbolizes by way of example a non-state-based check, and block 12b symbolizes by way of example a state-based check. The block 14, 15 symbolizes by way of example an optional further operation of the device 100, for example on the basis of the check 12.

In further exemplary embodiments, the checking apparatus 125 is designed as a hardware circuit, for example a pure hardware circuit, and thus for example has no software. This allows an efficient hardware-based check 12, for example according to predeterminable (and/or learnable or (fixedly) programmable) firewall rules or security rules, for example with regard to protocol data units PDU-1 that can potentially be processed by the device 100. In addition, software-based attacks on the hardware checking apparatus 125 or hardware firewall are ineffective.

In further exemplary embodiments, the checking apparatus 125 (FIG. 1) is designed to selectively check the at least one received protocol data unit PDU-1, for example on the basis of a first item of control information SI-1, for example a bit flag or characterizable by a bit flag. In other words, the checking apparatus 125 can e.g. check intermittently received protocol data units PDU-1, for example on the basis of the item of control information SI-1, which can be provided e.g. by another component 130 (see FIG. 7 below) of the device 100, and the checking apparatus 125 intermittently does not carry out any checking of protocol data units, for example. In further exemplary embodiments, a control as to whether e.g. a specific protocol data unit, for example a protocol data unit corresponding to at least one predeterminable criterion, is to be checked can be carried out, e.g. by the device 100 or another component 130 (FIG. 7) of the device (other than the checking apparatus 125). Alternatively or additionally, a control as to whether e.g. a certain protocol data unit is to be checked can be carried out by the checking apparatus 125 itself.

In further exemplary embodiments, the checking apparatus 125 is designed to check at least some received protocol data units PDU-1, for example all the received protocol data units.

In further exemplary embodiments, FIG. 2B, the checking apparatus 125 (FIG. 1) is designed to subject at least some received protocol data units to the non-state-based check 12a (FIG. 2A), cf. block 1200 according to FIG. 2B, and, for example on the basis of a result ERG-12a of the non-state-based check 12a, 1200, to subject at least some of the received protocol data units to the state-based check 12b, cf. block 1202 according to FIG. 2B. By way of example, the state-based check 12b, 1202 leads to a further result ERG-12b, which in further exemplary embodiments can be evaluated, for example, together with the result ERG-12a.

In further exemplary embodiments, the checking apparatus 125 is designed to check protocol data units that are associated with at least one protocol, for example at least one service-oriented protocol, that operates on layer 5 of the ISO/OSI reference model, for example protocol data units that are associated with a Scalable Service-Oriented Middleware over IP, SOME/IP, protocol.

In further exemplary embodiments, the checking apparatus 125 is designed to (also) check data units that are associated with other, possibly higher or lower ISO/OSI layers.

In further exemplary embodiments, FIG. 2A, it is also possible to check protocol data units associated with at least one other protocol and/or other types of protocol data units, e.g. L-PDUs, l-PDUs, N-PDUs, S-PDUs, e.g. by means of the checking apparatus 125.

FIG. 2C schematically shows a simplified block diagram according to exemplary embodiments, which diagram characterizes an exemplary header data format, for example header format, for example of the SOME/IP protocol, wherein the row ZE1 indicates a bit offset, wherein the range BER1 symbolizes a SOME/IP header, and wherein the range BER2 symbolizes data fields characterized by the length H2.

In further exemplary embodiments, cf. FIG. 2C, the checking apparatus 125 (FIG. 1) is designed to check at least one of the following elements, for example of header data, for example of a protocol data unit associated with the SOME/IP protocol during the check 12, for example during the non-state-based check 12a: a) a message identifier, for example message ID, H1 (e.g. having 32 bits), for example in relation to at least one predeterminable valid message identifier or message ID, wherein the at least one predeterminable valid message identifier can be organized, for example, in the form of a table, wherein, for example, checking the message ID comprises ascertaining whether the message ID H1 is a predeterminable valid message ID, b) a service identifier, for example service ID H1a (wherein, for example, checking the service ID H1a comprises ascertaining whether the service ID H1a is a predeterminable valid service ID), c) a method ID H1b (wherein, for example, checking the method ID H1b comprises ascertaining whether the method ID H1b is a predeterminable valid method ID), d) a length H2, for example in relation to a predeterminable length (wherein, for example, checking the length H2 comprises ascertaining whether the length H2 corresponds e.g. to the predeterminable (e.g. valid) length), e) a request identifier, for example request ID, H3, for example having 32 bits, for example in relation to a predeterminable value (wherein, for example, checking the request ID H3 comprises ascertaining whether the request ID H3 is a predeterminable valid request ID), f) a client identifier, for example client ID H3a (wherein, for example, checking the client ID H3a comprises ascertaining whether the client ID H3a is a predeterminable valid client ID), g) a session identifier, for example session ID H3b (wherein, for example, checking the session ID H3b comprises ascertaining whether the session ID H3b is a predeterminable valid session ID), h) a protocol version H4, for example having 8 bits, (for example by ascertaining whether the protocol version corresponds to a predeterminable valid protocol version), i) an interface version H5, for example having 8 bits, (for example by ascertaining whether the interface version corresponds to a predeterminable valid interface version), j) a type, for example message type, H6, for example having 8 bits, (for example by ascertaining whether the message type corresponds to a predeterminable valid message type), j) a return value, for example return code H7, for example having 8 bits, (for example by ascertaining whether the return code corresponds to a predeterminable valid return code).

In further exemplary embodiments, FIG. 2D, the checking apparatus 125 (FIG. 1) is designed to check 1210, for example in the state-based check 12b, whether a) a response message RESP-MSG has been received after the sending of a request message, for example associated with the response message RESP-MSG, and/or whether b) a received response message RESP-MSG is associated with a previously sent request message, and/or whether c) a received response message RESP-MSG has been received within a predeterminable response time in relation to the sending of a request message associated with the response message RESP-MSG. The optional block 1212 symbolizes an evaluation of results of the check 1210, e.g. for the presence of at least one of the criteria a), b), c).

In further exemplary embodiments, FIG. 3, the checking apparatus 125 is designed to ascertain 22 a message type SOME/IP-N-TYPE of at least one SOME/IP message that is associated with the at least one received protocol data unit PDU-1, wherein, for example, the message type SOME/IP-N-TYPE has at least one of the following elements: a) REQUEST, b) REQUEST_NO_RETURN, C) NOTIFICATION, d) RESPONSE, e) ERROR, f) TP_REQUEST, g) TP_REQUEST_NO_RETURN, h) TP_NOTIFICATION, i) TP_RESPONSE, j) TP_ERROR. The optional block 20 according to FIG. 3 symbolizes a reception of the protocol data unit PDU-1, e.g. similar to block 10 according to FIG. 2A.

In further exemplary embodiments, the checking apparatus 125 is designed to ascertain 24 a service type SOME/IP-D-TYPE of at least one SOME/IP message that is associated with the at least one received protocol data unit PDU-1, wherein, for example, the service type SOME/IP-D-TYPE comprises at least one of the following elements: a) RPC, remote procedure call, b) Fire & Forget, c) Notify.

In further exemplary embodiments, the block 22 according to FIG. 3 and/or the block 24 according to FIG. 3 can, for example, be part of the check 12 according to FIG. 2A.

In further exemplary embodiments, FIG. 4, the checking apparatus 125 (FIG. 1) is designed to carry out a state-based and/or state-oriented evaluation of at least one SOME/IP service 28 (FIG. 4), for example of remote procedure calls, for example comprising request elements and/or response elements, for example on the basis of the at least one received protocol data unit PDU-1, cf. the block 26 according to FIG. 4, which symbolizes the reception of the protocol data unit PDU-1 by way of example.

In further exemplary embodiments, the checking apparatus 125 (FIG. 1) is designed to at least occasionally also carry out non-state-based and/or non-state-oriented evaluations, e.g. of SOME/IP services and/or other services and/or protocols or the data units associated therewith, cf. block 12a (FIG. 2A).

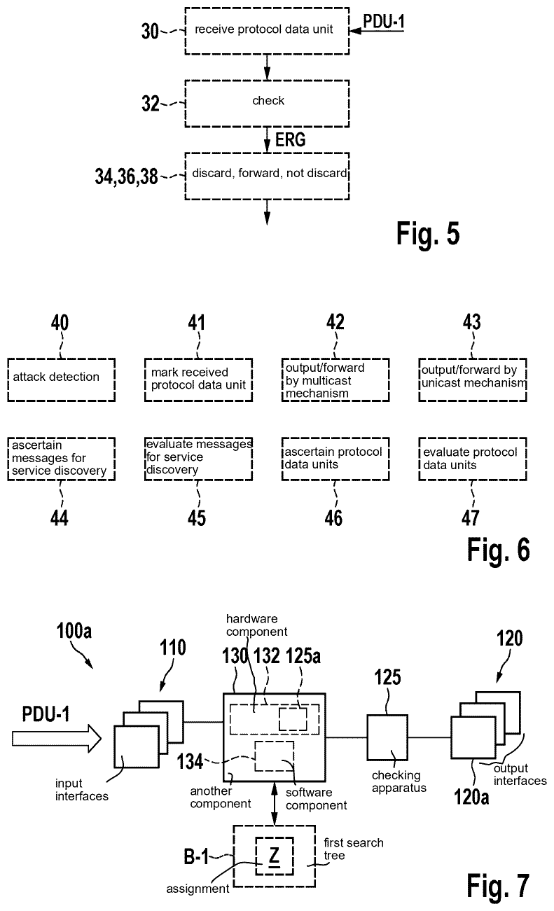

In further exemplary embodiments, FIG. 5, the checking apparatus 125 is designed to discard 34 the at least one received protocol data unit PDU-1 (for example, if a result ERG of the check 32 indicates an attempted attack or a malicious data unit) or not to discard it 38, for example to leave it unchanged (for example, if the result ERG of the check 32 does not indicate an attempted attack or a malicious data unit), e.g. on the basis of the check 32.

In further exemplary embodiments, the checking apparatus 125 is designed not to discard the at least one received protocol data unit PDU-1, for example to forward it 36, for example for output (see e.g. element 120, 120a according to FIG. 1), e.g. to another unit, e.g. on the basis of the check 32, for example if a result ERG of the check 32 does not indicate an attempted attack or a malicious data unit. The optional block 30 according to FIG. 5 symbolizes, by way of example, the reception of the protocol data unit PDU-1.

In further exemplary embodiments, the checking apparatus 125 is designed to modify or influence the at least one received protocol data unit PDU-1 and/or an output of the at least one received protocol data unit, for example via an output interface 120a (FIG. 1), for example in order to effect a unicast output or a multicast output.

In further exemplary embodiments, FIG. 6, the checking apparatus 125 is designed to carry out at least one of the following elements: a) attack detection 40, e.g. intrusion detection, and/or attack detection and attack prevention, e.g. intrusion detection and prevention, b) marking 41 of the at least one received protocol data unit PDU-1, for example on the basis of the check 12, 32 and/or on the basis of a result ERG of the check, c) outputting and/or forwarding 42 of the at least one received protocol data unit PDU-1 by means of a multicast mechanism, for example to at least one software component 134 (see FIG. 7 below), for example for, e.g. further, evaluation or execution of, e.g. software-based, attack detection, d) outputting and/or forwarding 43 the at least one received protocol data unit PDU-1 by means of a unicast mechanism, for example to at least one software component or the at least one software component 134, for example for, e.g. further, evaluation or execution of, e.g. software-based, attack detection, e) ascertaining 44 and/or evaluating 45 messages for service discovery, for example service discovery messages, which are based for example on a network protocol, e.g. a connectionless network protocol, for example on a user datagram protocol, UDP, f) ascertaining 46 and/or evaluating 47 protocol data units of the AUTOSAR l-PDU type, for example for a check, for example a security check.

In further exemplary embodiments, see FIG. 7, 8, 9, the device 100a has a processing apparatus 130 that is designed to perform a search 200 (FIG. 9) in at least one first search tree B-1 (FIG. 7, 8) on the basis of a PDU identifier associated with a received protocol data unit PDU-1, which search has an assignment Z of one PDU identifier MSG-ID, e.g. a message identifier, e.g. message ID, to a connection identifier VB-ID characterizing at least one data connection, wherein, for example, the search 200 can be performed before and/or after and/or at least partially simultaneously with the check 12 (FIG. 2A). In further exemplary embodiments, the search 200 can be used, for example, for routing, e.g. forwarding, the data unit.

In further exemplary embodiments, for example, if the check 12 is carried out before the search 200, the search 200 can be performed e.g. on the basis of a result ERG of the check 12.

In further exemplary embodiments, for example, if the check 12 is carried out after the search 200, the check 12 can be performed e.g. on the basis of a result of the search, for example on the basis of the connection identifier VB-ID, and/or on the basis of information associated with the connection identifier VB-ID. In further exemplary embodiments, it can thus be achieved, for example, that a check 12 of the relevant data units PDU-1 is performed by means of the checking apparatus 125 for specific connection identifiers, whereas no check of the relevant data units is performed by means of the checking apparatus 125 for other connection identifiers, for example.

In further exemplary embodiments, the device 100a is designed to ascertain 202 (FIG. 9) a connection identifier VB-ID associated with the received protocol data unit PDU-1 on the basis of the received protocol data unit PDU-1, wherein, for example, the ascertainment 202 can be performed before and/or after and/or at least partially simultaneously with the check 12.

In further exemplary embodiments, the processing apparatus 130 has at least one hardware component 132, which is designed to perform the search 200 in the first search tree B-1 and/or to ascertain 202 the connection identifier VB-ID associated with the received protocol data unit PDU-1. The hardware-based search can, for example, be carried out particularly quickly and efficiently and, like a hardware-based (firewall) check 12 of data units, is insensitive to software-based attempted attacks.

In further exemplary embodiments, the first search tree B-1 is a binary tree.

In further exemplary embodiments, the first search tree B-1 is a ternary or n-nary, n>3, tree.

In further exemplary embodiments, the device 100a is designed to output, on the basis of the connection identifier VB-ID-1 associated with the received protocol data unit PDU-1, the received protocol data unit PDU-1 and/or data derivable or derived therefrom to at least one specific output interface 120a (FIG. 1, 7) of the second number of output interfaces 120, see the optional block 204 according to FIG. 9.

In further exemplary embodiments, at least part of the functionality of the checking apparatus 125 is realized by means of the hardware component 132, cf. the element 125a according to FIG. 7. In further exemplary embodiments, the checking apparatus 125 can also be fully integrated into the hardware component 132.

In further exemplary embodiments, the checking apparatus 125 can also be formed and/or arranged separately from the hardware component 132 of the processing apparatus 130.

In further exemplary embodiments, the processing apparatus 130 has at least one software component 134, wherein the software component 134 is designed to perform at least one of the following elements: a) at least temporarily forming 210 (FIG. 10) the first search tree B-1, b) at least temporarily modifying, for example balancing, 212 the first search tree B-1, wherein, for example, a balanced first search tree B-1′ is obtained, c) receiving 214 the at least one protocol data unit PDU-1 from the checking apparatus 125 (for example, if it is concluded on the basis of the result ERG of the check 12, 32 of the protocol data unit by the checking apparatus 125 that a, for example further, software-based check of the protocol data unit should be carried out), d) evaluating 216, for example performing, e.g. software-based, attack detection.

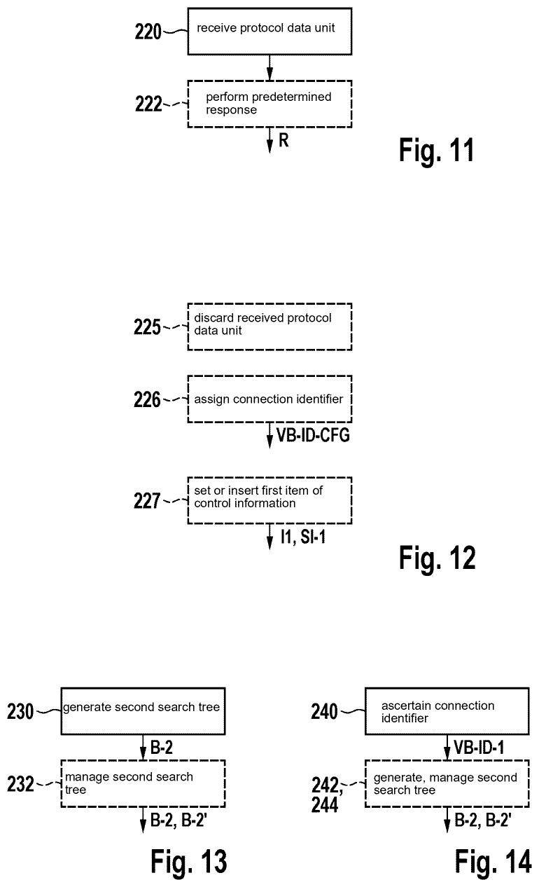

In further exemplary embodiments, FIG. 11, 12, the at least one software component 134 is designed to perform a predeterminable response R 222 if no connection identifier associated with the received protocol data unit can be ascertained for the received protocol data unit PDU-1, for example if no connection identifier associated with the received protocol data unit is present for the received protocol data unit in the first search tree B-1, wherein, for example, the predeterminable response R has at least one of the following elements: a) discarding 225 (FIG. 12) the received protocol data unit, b) assigning 226 a connection identifier VB-ID-CFG, for example a configurable connection identifier, to the received protocol data unit, c) setting or inserting 227 a first item of information I1 or first item of control information SI-1 for the received protocol data unit, for example in the form of a bit flag, wherein the first item of information I1 and/or the first item of control information SI-1 indicates, for example, that the received protocol data unit is to be subjected to a check 12, for example by means of the checking apparatus 125, for example firewall apparatus. In further exemplary embodiments, the block 220 according to FIG. 11 symbolizes a reception of the protocol data unit PDU-1.

In further exemplary embodiments, for the checking apparatus 125 is designed to evaluate the first item of information I1 and/or the first item of control information SI-1 and, on the basis thereof, to perform or not perform a check 12 of the data unit in question. For example, the checking apparatus 125 can check the data unit in question if a bit flag corresponding to the information I1, SI-1 is set, whereas the checking apparatus 125 does not check the data unit in question if a bit flag corresponding to the information I1, SI-1 is not set.

In further exemplary embodiments, FIG. 13, the device 100, 100a (FIG. 1, 7), for example the at least one software component 134, is designed to generate 230 (FIG. 13), for example on the basis of the first search tree B-1, a second search tree B-2 and/or to manage 232 it, for example to modify it, wherein, for example, a modified second search tree B-2′ can be obtained.

In further exemplary embodiments, the first search tree B-1 and/or the second search tree B-2 is a red-black tree.

In further exemplary embodiments, the first search tree B-1 is a binary tree, for example without color information (for example, red/black), and the second search tree B-2 is a red-black tree. This enables an efficient, for example hardware-based, search, for example by means of the at least one hardware component 132, in the first search tree B-1, wherein, for example, no color information is available for the search, whereas, in further exemplary embodiments, for example for efficient management of the second search tree B-2, the second search tree B-2 is designed as a red-black tree.

In further exemplary embodiments, the device 100 is designed to organize the first search tree B-1 and/or the second search tree B-2 at least temporarily in the form of at least one table.

In further exemplary embodiments, FIG. 14, the device 100, 100a is designed to, at least partially simultaneously: a) ascertain 240, on the basis of the received protocol data unit PDU-1, a connection identifier VB-ID-1 associated with the received protocol data unit PDU-1, for example by means of the at least one hardware component 132, for example by performing the search in the first search tree B-1 by means of the at least one hardware component 132, and b) generate 242, for example by means of the at least one software component 134, a or the second search tree B-2, for example on the basis of the first search tree B-1 (for example by copying the first search tree B-1), and/or to manage 244 it, for example to modify it (for example transforming it into a red-black tree and/or changing the elements or structure of the search tree).

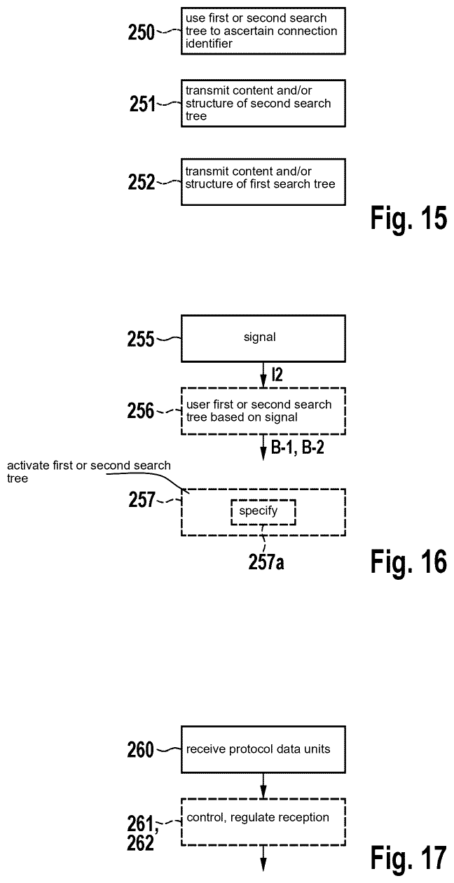

In further exemplary embodiments, FIG. 15, the device 100, 100a is designed to perform at least one of the following elements: a) using 250 the first search tree B-1 or the second search tree B-2 at least temporarily, for example selectively, for example to ascertain the connection identifier VB-ID-1 associated with the received protocol data unit PDU-1, b) transmitting 251 a content and/or a structure of the second search tree B-2 to the first search tree B-1 (for example, in order to make a search tree B-2, B-2′ that is modified, for example balanced, for example by means of the software component 134, in relation to the first search tree B-1, which can be searched, for example by means of the hardware component 132), c) transmitting 252 a content and/or a structure of the first search tree B-1 to the second search tree B-2 (for example, in order to prepare a modification that can be performed e.g. by means of the software component 134).

In further exemplary embodiments, FIG. 16, the device 100, 100a, for example the at least one software component 134, is designed to signal 255, for example to the at least one hardware component 132, at least one of the following elements, for example by means of a second item of information I2: a) the first search tree B-1 is to be used for performing the search, b) the second search tree B-2 is to be used for performing the search, c) a modification of the first search tree B-1 and/or of the second search tree B-2, for example an insertion of at least one node and/or a balancing of the search tree in question, has been completed.

In further exemplary embodiments, the device 100, for example the at least one hardware component 132, is designed to use 256, based on the signaling 255, the first search tree B-1 or the second search tree B-2 for performing the search.

In further exemplary embodiments, the device 100, 100a, for example the at least one hardware component 132, is designed to activate 257 the first search tree B-1 or the second search tree B-2 for performing the search between two, for example successive, searches, for example for performing the search or searches in future, for example by specifying 257a which of the two search trees is to be used from then on for performing the search or searches.

In further exemplary embodiments, FIG. 17, the device 100, 100a is designed to control 261 or regulate 262 a rate at which protocol data units are output via at least one output interface of the second number of output interfaces. For example, the block 260 in FIG. 17 symbolizes a reception of protocol data units for which the mentioned rate is controlled 261 or regulated 262 in further exemplary embodiments.

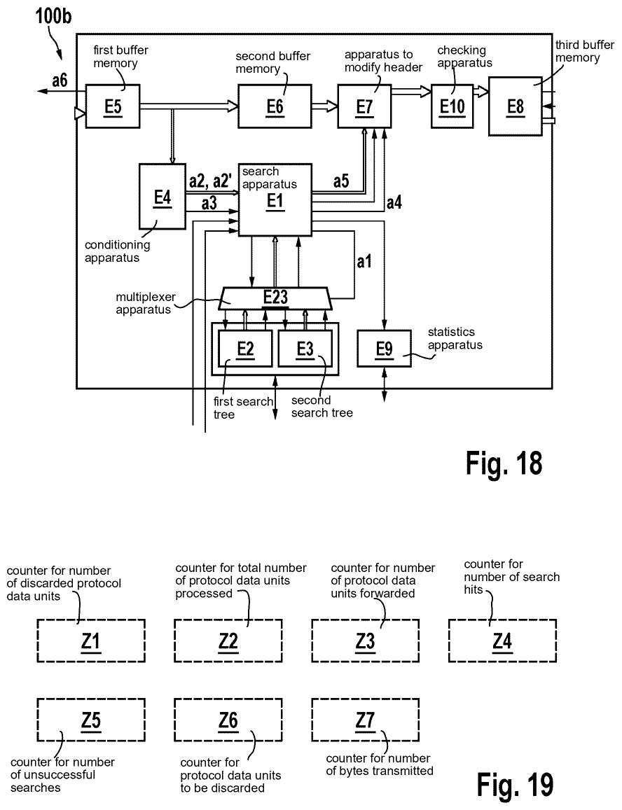

FIG. 18 schematically shows a simplified block diagram of a device 100b according to exemplary embodiments, which in further exemplary embodiments can have a functionality comparable to the device 100 according to FIG. 1 and/or to the device 100a according to FIG. 7. Block E1 according to FIG. 18 symbolizes a search apparatus, for example a search apparatus implementable in the form of hardware, for example by means of or comparable to the hardware component 132 according to FIG. 7.

Block E2 symbolizes the first search tree B-1 (FIG. 71), for example a search tree that can be organized in the form of a first table, which in further exemplary embodiments, for example, can be referred to as a “work table.” Block E3 symbolizes the second search tree B-2 (FIG. 13), for example a search tree that can be organized in the form of a second table, which in further exemplary embodiments, for example, can be referred to as a “shadow table.”

In further exemplary embodiments, the device 100b has a multiplexer apparatus E23, via which the search apparatus E1 can, for example, selectively access the first table E2 or the second table E3, for example in order to perform a search, cf. block 200 according to FIG. 9. In further exemplary embodiments, selection of the first table E2 or of the second table E3 can be realized e.g. by means of a control signal a1, which in further exemplary embodiments can e.g. form the search apparatus E1 and/or output it to the multiplexer apparatus E23.

In further exemplary embodiments, the device 100b has at least one memory for at least temporarily storing one or more, e.g. received, protocol data units PDU-1 (FIG. 1) or parts of one or more protocol data units. The device 100b has, for example, a first buffer memory E5, which can e.g. at least temporarily store incoming protocol data units or protocol data units that can be received or are received by the device 100b, for example according to the FIFO (first in first out) principle. Optionally, the first buffer memory E5 can also perform a desegmentation of received protocol data units, at least temporarily.

In further exemplary embodiments, the device 100b has a second buffer memory E6, which can be used, for example, for “delaying” at least one received protocol data unit, i.e., for example, for temporarily buffering the received protocol data unit or at least part of the received protocol data unit, for example until the protocol data unit is output, for example at a possibly predeterminable later point in time.

In further exemplary embodiments, the second buffer memory E6 is designed to delay a received protocol data unit until the search apparatus E1 has ascertained the connection identifier VB-ID-1 associated with the received protocol data unit PDU-1, for example by a search performed in the first search tree B-1, E2, for example by means of the hardware component 132, E1.

In further exemplary embodiments, a storage capacity or storage size of the second buffer memory E6 can be predetermined based on a maximum search duration in the first search tree B-1. For example, when using a binary first search tree B-1 in further exemplary embodiments, it can be assumed that a maximum search duration is proportional to a logarithm, for example a logarithm dualis (Id), of a number of nodes of the search tree and to a number of clock cycles required for reading and evaluating a node of the search tree.

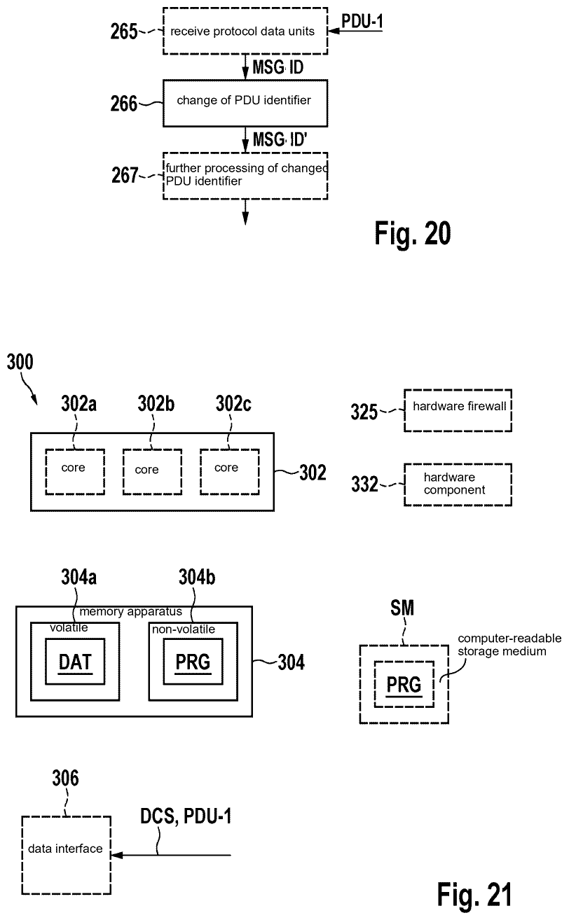

In further exemplary embodiments, the device 100b has a conditioning apparatus E4, which is designed to change, for example normalize, a PDU identifier associated with a received protocol data unit. FIG. 20 schematically shows a simplified flow chart according to further exemplary embodiments, wherein block 265 symbolizes an optional reception of a protocol data unit PDU-1, wherein block 266 symbolizes the changing of a PDU identifier MSG-ID associated with a received protocol data unit, wherein e.g. a changed PDU identifier MSG-ID′ is obtained. The optional block 267 symbolizes a further processing of the changed PDU identifier MSG-ID′ according to further exemplary embodiments, for example a performance of a search in the first search tree B-1, E2 based on the changed PDU identifier MSG-ID′.

In further exemplary embodiments, the conditioning apparatus E4 is designed to form a search vector a2, which can be transmitted to the search apparatus E1, for example.

In further exemplary embodiments, the search vector a2 can have at least one of the following elements: a) a PDU identifier MSG-ID associated with the received protocol data unit PDU-1, b) information rxbus characterizing a, for example virtual, input interface that corresponds to e.g. a virtual device identifier of a virtual device via which the protocol data unit PDU-1 has been received, c) information rembus characterizing e.g. for at least one type of received protocol data unit PDU-1, e.g. for an L-PDU type, a remote receive bus of the L-PDU.

In further exemplary embodiments, the search vector a2, also referred to as “searchVector,” can also have e.g. the three aforementioned elements a), b), c): searchVector={rxbus, rembus, msgid}, wherein msgid characterizes the PDU identifier MSG-ID.

In further exemplary embodiments, the search apparatus E1 is designed to compare the search vector a2 with reference vectors of the first table E2, wherein, for example, the reference vectors define a format or one of a plurality of possible formats.

In further exemplary embodiments, one or more of the following formats can be used for the PDU identifier MSG-ID, e.g. on the basis of a relevant input interface 110, via which a protocol data unit PDU-1 has been received: a) e.g. protocol data units associated with a CAN (controller area network) protocol or CAN bus, e.g. of the I-PDU type (interaction layer protocol data unit, e.g. according to AUTOSAR), b) 11-bit standard ID, c) 29-bit extended ID, d) 32-bit message ID, e.g. of a CAN-XL acceptance field, e) I-PDUs associated with a LIN (local interconnect network) bus, f) AUTOSAR dynamic I-PDU multiplexing using UDP or CAN as transport layer (ASAR sockets in TUNETH DEV or CAN sockets in TUNCAN DEV), g) SomeIP S-PDU multiplexing (SomeIP socket in TUNETH DEV or CAN sockets in TUNCAN DEV), h) AVTP P1722 L-PDU multiplexing (AVB socket in TUNETH DEV).

In further exemplary embodiments, the conditioning apparatus E4 is designed to form a search vector a2, for example a compatible search vector, for example by normalizing the aforementioned formats for the PDU identifier MSG-ID, wherein, for example, a normalized search vector a2′ is obtained. For example, the search vector a2 and/or the normalized search vector a2 can have 32 bits.

In further exemplary embodiments, a function of the conditioning apparatus E4 can be characterized e.g. by the following pseudocode (“pseudocode 1”).

```
******** Pseudocode 1 - START ********
-- copy receive bus into search vector
searchVector, rxbus = tlv.rxbus
-- CAN 1-PDU input
If tlv.messageType == CLF_TLV_CAN_DATA then
  searchVector.rembus = 0
  noSearch = false
  validMsg=true
  If tlv.word64[4] .XDAT == 1 then
    -- CAN-XL
    searchVector.msgid = tlv.word64{5] & 0xFFFFFFFF00000000
else
    -- standard CAN and CAN-FD If tlv.word64[4] .EXT == 1 then
    SearchVector.msgid = tlv.word64[4] & 0x000000003FFF0000
else
    SearchVector.msgid = tlv.word64[4] & 0x000000001FFFFFFF
  end
end
-- LIN 1-PDU input
elseif tlv.messageType == CLF_TLV_LIN_DATA then
  searchVector.rembus = 0
  searchVector.msgid = tlv.word64[4] & 0x3F
  noSearch = false
-- AUTOSAR 1-PDU multiplex input with LONG ID or
-- SomelP S-PDU multiplex input with LONG ID
elseif tlv.messageType == CLF_TLV_PDU_LONG then
  searchVector.rembus = 0
  searchVector.msgid = tlv.word64[5] & 0x00000000FFFFFFFF
  noSearch = false
-- AUTOSAR 1-PDU multiplex input with SHORT ID
elseif tlv.messageType == CLF_TLV_PDU_SHORT then
  searchVector.rembus = 0
  searchVector.msgid = tlv. word64[5] & 0x0000000000FFFFFF
  noSearch = false
-- AVBTP L-PDU multiplex input with CAN ID
elseif tlv.messageType == CLF_TLV_P1722_CAN then
  searchVector.rembus = tlv.rembus
  searchVector.msgid = tlv.word64[4] & 0x000000001FFFFFFF
  noSearch = false
-- AVBTP L-PDU multiplex input with CAN ID
elseif tlv.messageType == CLF_TLV_P1722_CAN_BRIEF then
  searchVector.rembus = tlv.rembus
  searchVector.msgid = tlv.word64[4] & 0x000000001FFFFFFF
  noSearch = false
-- AVBTP L-PDU multiplex input with LIN ID
elseif tlv.messageType == CLF_TLV_P1722_LIN then
  searchVector.rembus = tlv.rembus
  searchVector.msgid = tlv.word64[4] & 0x3F
  noSearch = false
-- AVBTP General Purpose control message
elseif tlv.messageType == CLF_TLV_P1722_GPC
  searchVector.rembus = 0
  searchVector.msgid = 0
  noSearch = true
else
  skipCount = skipCount + 1
  noSearch = true
  validMsg=true
end
******** Pseudocode 1 - END ********
```

In further exemplary embodiments, the “noSearch” variable provided in the above pseudocode 1 can be used to characterize whether or not a search is to be performed by the search apparatus E1. The information associated with the noSearch variable can be transmitted to the search apparatus E1 by the conditioning apparatus E4 in further exemplary embodiments, cf. e.g. the arrow a3 according to FIG. 18.

In further exemplary embodiments, the “validMsg” variable provided in the above pseudocode 1 can be used to be able to distinguish between valid and invalid messages or data frames.

In further exemplary embodiments, the query “—AVBTP General Purpose control message elseif tlv.messageType==CLF_TLV_P1722_GPC” contained in the above pseudocode 1 can be used to ensure that no search is performed for a PDU identifier with the format/type AVBTP or CLF_TLV_P1722_GPC. For example, in further exemplary embodiments, a configurable connection identifier VB-ID-CFG (cf. e.g. block 226 according to FIG. 12) can be predetermined for such types of PDU identifiers, that is, without a preceding search, for example.

In further exemplary embodiments, a or the configurable connection identifier VB-ID-CFG can be used for such PDU identifiers for which no search is performed.

In further exemplary embodiments, the device 100b has an apparatus E7 for modifying header data, which apparatus is designed e.g. to selectively discard a protocol data unit PDU-1, for example on the basis of a control a4 by the search apparatus E1, e.g. if the search by the search apparatus E1 has not produced a result.

In further exemplary embodiments, the device 100b has a third buffer memory E8, which can at least temporarily buffer protocol data units to be output and, optionally, can at least temporarily perform a segmentation.

In further exemplary embodiments, the device 100b has a statistics apparatus E9, which is designed to ascertain or manage statistical information with respect to an operation of the device 100, 100a, 100b or of the search apparatus E1.

Block E10 according to FIG. 18 symbolizes, for example, a checking apparatus, for example a firewall apparatus, for example at least similar to the checking apparatus 125 according to FIG. 1.

In further exemplary embodiments, the device 100b, for example the statistics apparatus E9, is designed to manage at least one of the following counters mentioned by way of example, FIG. 19, a) counter Z1 for a number of discarded protocol data units, b) counter Z2 for a total number of protocol data units processed by the device 100, 100a, 100b, c) counter Z3 for a number of protocol data units forwarded by means of the device 100, 100a, 100b, d) counter Z4 for a number of search hits of the search apparatus E1, e) counter Z5 for a number of unsuccessful searches by means of the search apparatus E1, f) counter Z6 for protocol data units to be discarded, which are e.g. damaged, for which e.g. the conditioning apparatus E4 indicates that they are to be discarded, for example with the exception of protocol data units of the type AVB P1722 GPC, g) counter Z7 for a number of bytes that have been transmitted by the device 100, 100a, 100b.

In further exemplary embodiments, at least one of the aforementioned counters Z1, Z2, . . . , Z7 has a data width of 32 bits, which in further exemplary embodiments allows e.g. comparatively low-frequency polling (e.g. every second or less often than once per second), e.g. by means of software, e.g. by means of the software component 134 (FIG. 7).

In further exemplary embodiments, a design of the search apparatus E1 (FIG. 18) can depend on a search algorithm used.

In further exemplary embodiments, the following exemplary embodiments for the search algorithm are possible, wherein both of the following exemplary embodiments are variants of e.g. a binary search and use e.g. a work table E2 (FIG. 18) and a shadow table E3.

In further exemplary embodiments, the work table E2 is used e.g. by the hardware component 132 (FIG. 7), for example for performing 200 the search (FIG. 9) and/or for ascertaining 202 a connection identifier VB-ID-1 associated with the received protocol data unit PDU-1.

In further exemplary embodiments, the shadow table E3 is used e.g. by the software component 134, e.g. to change the lookup table, for example if entries are added and/or removed, for example during a runtime of the device 100, 100a, 100b.

In further exemplary embodiments, for example, a binary sorted table can be used, which has e.g. a sorted plurality (“array”) of reference vectors, e.g. the aforementioned reference vectors. In further exemplary embodiments, for example, each entry of the binary sorted table can be designated as a node.

In further exemplary embodiments, for example, a search tree, for example a balanced search tree, for example a red-black tree, can be used, see e.g. the above description of the first search tree B-1 and the second search tree B-2. In further exemplary embodiments, for example, at least one of the search trees B-1, B-2 can be organized in the form of a table.

In further exemplary embodiments, a node structure for the at least one search tree B-1, B-2 can, for example, be characterized according to:

| | |
|---|---|
| node = { | refVector = { |
| | rxbus (8 bit) |
| | rembus (8 bit) |
| | msgid (32 bit) |
| | } |
| | attrib = { |
| | tlv = { |
| | pduCid (Iog2 (entries) bit) |
| | canpad (4 bit) |
| | color (1 bit) |
| | modcmd (2 bit) |
| | modparam (11 bit) } |
| | sec = { secGen (1 bit) secChk (1 bit) } |
| | fw (1 bit) |
| | nodeLeft (Iog2 (entries) bit) |
| | nodeRight (Iog2 (entries) bit) |
| | }, |

wherein refVector characterizes a reference vector, wherein the reference vector can, by way of example, have the elements rxbus (with e.g. 8 bits), rembus (with e.g. 8 bits), msgid (with e.g. 32 bits) already described above,
wherein attrib characterizes optional attributes for a node,
wherein see characterizes attributes associated with a possible authentication,
wherein fw characterizes an optional attribute that indicates whether a security check, for example an optional security check, for example by means of the checking apparatus 125, E10, e.g. firewall, is to be performed for a relevant protocol data unit or for protocol data units associated with a connection identifier pduCid,
wherein nodeLeft characterizes the left child node in the binary search tree,
wherein nodeRight characterizes the right child node in the binary search tree, and
wherein color characterizes a color attribute for the search tree.

In further exemplary embodiments, for example, a binary search tree, for example a binary search tree that can be stored or is stored in a hardware memory, can have the component “color.” This can be used in further exemplary embodiments to be able to modify the search tree, for example on an “in-memory” basis (i.e., directly in the memory), for example without having to create a copy, for example an expensive copy, in the working memory of the software.

In further exemplary embodiments, the search tree that can be evaluated by the hardware component 132, for example the first search tree B-1, has no color information (red-black) for its nodes. In further exemplary embodiments, this color information (red-black) is provided and/or used e.g. if nodes are added and/or removed, which operations are performed, for example, on the second search tree B-2, for example by means of the software component 134. In further exemplary embodiments, for example, the color information (red-black) associated with the nodes of the second search tree B-2 can thus be kept or at least temporarily stored in a table that can be managed by means of the software component 134.

In further exemplary embodiments, the search tree that can be evaluated by means of the hardware component 132, for example the first search tree B-1, has color information (for example, red-black) for its nodes, for example nodes realizable by means of the aforementioned “color” component.

The above embodiments mentioned by way of example based on a binary search advantageously require a search effort that is comparatively small, since it is logarithmic, based on the total number of elements of the search tree or table concerned.

In further exemplary embodiments, in the event of a successful search 200 (FIG. 9), the search apparatus E1 transmits the optional attributes attrib for the node, for example of the search tree B-1, found in the search 200 to the apparatus E7 for modification of header data, cf. the arrow a5 according to FIG. 18. In this case, for example, no discarding of the protocol data unit PDU-1 concerned is signaled, see arrow a4 already described above with reference to FIG. 12.

In further exemplary embodiments, the search apparatus E1 performs at least one of the following actions in the event of an unsuccessful search 200: a) instructing the apparatus E7, e.g. by means of arrow a4, to discard the protocol data unit PDU-1 (wherein, for example, the counter Z6, FIG. 19, can also be incremented), b) inserting a, e.g. static and/or configurable, connection identifier VB-ID-CFG (and/or setting a firewall flag fw, which indicates that the protocol data unit PDU-1 is to be subjected to a security check, for example by the firewall apparatus 125, E10).

In further exemplary embodiments, a data structure, for example a node structure, for the at least one search tree B-1, B-2 (see e.g. the “node” structure already described above by way of example) has an attribute that indicates whether a security check is to be performed, for example by means of the checking apparatus 125, E10, for a relevant protocol data unit or for protocol data units associated with a connection identifier. For example, the attribute can be characterized by the aforementioned bit flag “fw” and/or correspond to the first item of information 11 or first item of control information SI-1 (FIG. 1).

In further exemplary embodiments, the checking apparatus 125 (FIG. 1) is designed to use the connection identifier VB-ID, for example for ascertaining a service associated with the at least one received protocol data unit, for example, and/or an identifier.

Further exemplary embodiments, FIG. 2A, relate to a method, for example a computer-implemented method, for processing data units PDU-1, for example protocol data units, for a device 100, 100a, 100b, for example according to the embodiments, having a first number 110 of input interfaces for receiving protocol data units and, optionally, a second number 120 of output interfaces for outputting protocol data units, and a checking apparatus 125, for example a firewall apparatus, that is designed to check at least one received protocol data unit, for example to subject it to a security check, the method comprising: receiving 10 (FIG. 2A) at least one protocol data unit PDU-1, checking 12 the received at least one protocol data unit PDU-1 by means of the checking apparatus 125, wherein the checking apparatus 125 at least occasionally carries out at least one of the following checks: a) a non-state-based, for example non-state-oriented, for example stateless, check 12a, for example with respect to the least one received protocol data unit, b) a state-based, for example state-oriented, for example stateful, check 12b, for example with respect to the least one received protocol data unit.

In further exemplary embodiments, the method comprises at least one of the following elements: a) outputting 14 the at least one protocol data unit, for example on the basis of the check 12, b) discarding 15 the at least one protocol data unit, for example on the basis of the check 12.

In further exemplary embodiments, the checking apparatus 125 subjects at least some received protocol data units to the non-state-based check and, for example on the basis of a result of the non-state-based check, subjects at least some of the received protocol data units to the state-based check.

In further exemplary embodiments, the checking apparatus 125 modifies or influences the at least one received protocol data unit and/or an output of the at least one received protocol data unit, for example via an output interface.

Further exemplary aspects and embodiments are described below, which in further exemplary embodiments can each be combined individually or in any combination with one another with at least one of the aspects described above by way of example.

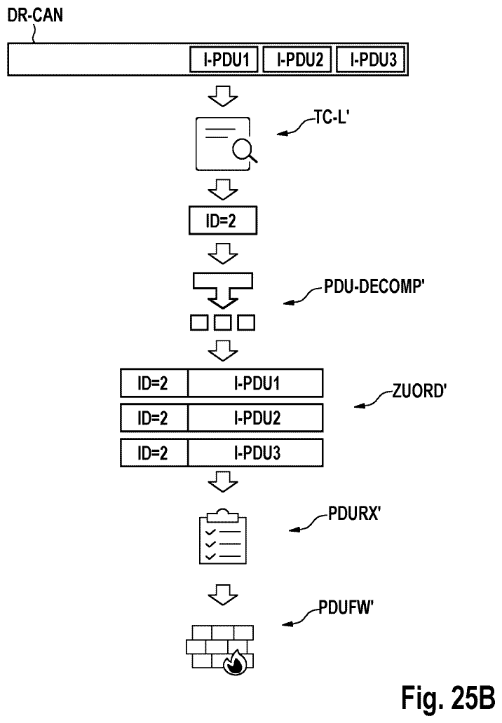

In further exemplary embodiments, FIG. 24A, the method comprises at least one of the following elements: a) receiving 1300 data, for example in the form of a data frame DR, b) ascertaining 1202 an endpoint EP associated with the reception 1300 of the data, for example an input interface associated with the reception of the data, for example a socket, for example a user datagram protocol, UDP, socket, for example by means of a ternary content addressable memory, TCAM, c) breaking down 1304, e.g. decomposing, the data frame DR into at least one protocol data unit, for example S-PDU, S-PDU1, S-PDU2, S-PDU3, d) assigning 1306 an identifier ID-EP characterizing the endpoint EP to the at least one protocol data unit S-PDU1, S-PDU2, S-PDU3, e) checking 1308, for example by means of the device 100, 100a, 100b and/or by means of the checking apparatus 125, at least one of the following elements of the at least one protocol data unit S-PDU1, S-PDU2, S-PDU3: e1) message identifier, for example message ID, H1 (see e.g. FIG. 2C), e2) request identifier, for example request ID, H3 (see e.g. FIG. 2C), e3) protocol version H4 (FIG. 2C), e4) interface version H5 (FIG. 2C), e5) type, for example message type, H6 (FIG. 2C), f) on the basis of the check 1308 (FIG. 24A) or on the basis of the result ERG-1308 of the check 1308, f1) outputting 1310 or forwarding the data, for example in the form of the data frame DR, or f2a) discarding 1312 the data, for example the data frame DR, and/or f2b) incrementing 1314 a counter DROP-CNT, which counts e.g. how many data frames DR are discarded. The counter value of the counter DROP-CNT can be used in further exemplary embodiments, e.g. for an attack detection method or system.

In further exemplary embodiments, the assignment 1306 of the identifier ID-EP characterizing the endpoint EP to the at least one protocol data unit S-PDU1, S-PDU2, S-PDU3 allows, for example, a check, e.g. a subsequent check, of the relevant protocol data unit S-PDU1, S-PDU2, S-PDU3, e.g. at least among other things (also) on the basis of the identifier ID-EP characterizing the endpoint EP, which further increases the flexibility and/or the security.

FIG. 24B schematically shows a simplified flow chart according to exemplary embodiments, which describes a process similar to FIG. 24A, for example, which can be used in further exemplary embodiments, e.g. for the implementation of a non-state-based (e.g. stateless) firewall function, e.g. for protocol data units associated with the SOME/IP protocol.

Element DR-ETH symbolizes an Ethernet data frame that arrives at the device 100, 100a, 100b or can be received or is received by the device, for example, and that has e.g. multiple protocol data units S-PDU1, S-PDU2, S-PDU3, inter alia. Element TC-L symbolizes an ascertainment of a UDP socket associated with the Ethernet data frame DR-ETH, in this case e.g. with the identifier “ID=2,” e.g. by means of a TCAM lookup; element PDU-DECOMP symbolizes a decomposition of the Ethernet data frame DR-ETH into the multiple protocol data units S-PDU1, S-PDU2, S-PDU3 contained therein or an ascertainment of the protocol data units S-PDU1, S-PDU2, S-PDU3 contained in the Ethernet data frame DR-ETH. Element ASSIGN symbolizes an assignment of the previously ascertained UDP socket or an identifier “ID=2” associated therewith to the ascertained protocol data units S-PDU1, S-PDU2, S-PDU3 contained in the Ethernet data frame DR-ETH.

The elements PDURX, PDUFW symbolize a check of the ascertained protocol data units S-PDU1, S-PDU2, S-PDU3 contained in the Ethernet data frame DR-ETH, for example by the device 100, 100a, 100b or by the checking apparatus 125, for example at least similarly to block 1308 according to FIG. 24A.

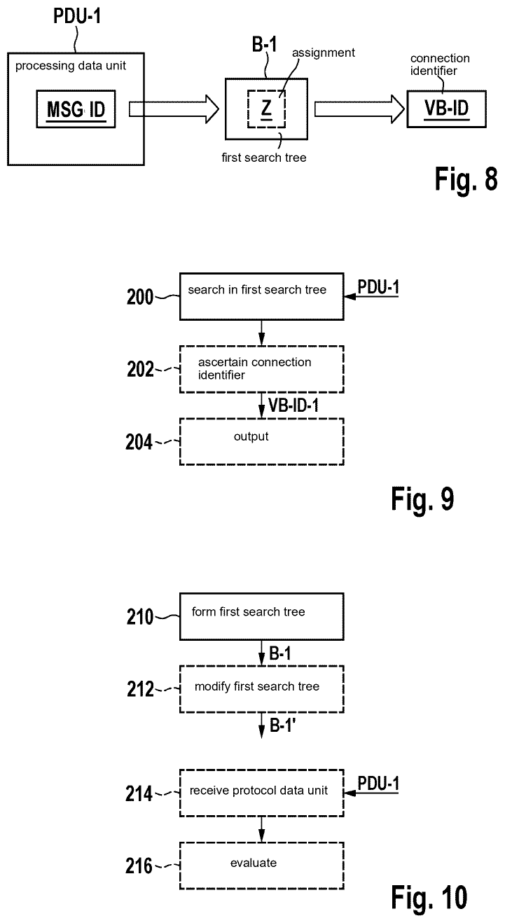

In exemplary embodiments, the device 100, 100a, 100b checks, for example by means of the processing apparatus 130 (FIG. 7), e.g. a message ID of the protocol data units S-PDU1, S-PDU2, S-PDU3, for example to ascertain a connection identifier VB-ID possibly associated with the message ID MSG-ID, see also e.g. FIG. 8.

In exemplary embodiments, the device 100, 100a, 100b checks, for example by means of the checking apparatus 125 (FIG. 1, 7), and e.g. on the basis of the e.g. previous check of the message ID MSG-ID, at least one of the following elements: e2) request identifier, for example request ID, H3 (see e.g. FIG. 2C), e3) protocol version H4 (FIG. 2C), e4) interface version H5 (FIG. 2C), e5) type, for example message type, H6 (FIG. 2C).

In further exemplary embodiments, FIG. 25A, the method comprises at least one of the following elements: a) receiving 1320 data, for example in the form of a data frame DR′, b) ascertaining 1322 an endpoint EP′ associated with the reception 1320 of the data, for example an input interface associated with the reception 1320 of the data, for example a socket, for example a controller area network, CAN, socket, for example by means of a ternary content addressable memory, TCAM, c) breaking down 1324, e.g. decomposing, the data frame DR′ into at least one protocol data unit, for example I-PDU, I-PDU1, I-PDU2, I-PDU3, d) assigning 1326 an identifier ID-EP′ characterizing the endpoint EP′ to the at least one protocol data unit I-PDU1, I-PDU2, I-PDU3, e) checking 1328, for example by means of the device 100, 100a, 100b or the checking apparatus 125, at least one of the following elements of the at least one protocol data unit I-PDU1, I-PDU2, I-PDU3: e1) message identifier, for example message ID, e2) length, f) on the basis of the check 1328, f1) outputting 1330 or forwarding the data, for example in the form of the data frame DR′, or f2a) discarding 1332 the data, for example the data frame DR′, and/or f2b) incrementing 1334 a counter DROP-CNT′. The counter value of the counter DROP-CNT′ can be used in further exemplary embodiments, e.g. for an attack detection method or system.

In further exemplary embodiments, the assignment 1326 of the identifier ID-EP′ characterizing the endpoint EP to the at least one protocol data unit I-PDU1, I-PDU2, I-PDU3 allows, for example, a check, for example a subsequent check, of the relevant protocol data unit I-PDU1, I-PDU2, I-PDU3, for example at least among other things (also) on the basis of the identifier ID-EP′ characterizing the endpoint EP, which further increases the flexibility and/or the security.

FIG. 25B schematically shows a simplified flow chart according to exemplary embodiments, which describes a sequence similar to FIG. 25A, for example, which can be used in further exemplary embodiments, for example for the implementation of a non-state-based (e.g. stateless) firewall function, e.g. for protocol data units, e.g. l-PDUs, associated with the CAN or CAN FD protocol.

Element DR-CAN symbolizes a CAN (or CAN FD) data frame that arrives at the device 100, 100a, 100b or can be received or is received by the device and that has, for example, multiple protocol data units I-PDU1, I-PDU2, I-PDU3, inter alia. Element TC-L′ symbolizes an ascertainment of a CAN socket associated with the CAN data frame DR-CAN, in this case e.g. with the identifier “ID=2,” e.g. by means of a TCAM lookup; element PDU-DECOMP′ symbolizes a decomposition of the CAN data frame DR-CAN into the multiple protocol data units I-PDU1, I-PDU2, I-PDU3 contained therein or an ascertainment of the protocol data units I-PDU1, I-PDU2, I-PDU3 contained in the Ethernet data frame DR-CAN. Element ASSIGN′ symbolizes an assignment of the previously ascertained CAN socket or an identifier “ID=2” associated therewith to the ascertained protocol data units I-PDU1, I-PDU2, I-PDU3 contained in the CAN data frame DR-CAN.

The elements PDURX′, PDUFW symbolize a check of the ascertained protocol data units I-PDU1, I-PDU2, I-PDU3 contained in the CAN data frame DR-CAN, for example by the device 100, 100a, 100b or by the checking apparatus 125, for example at least similarly to block 1328 according to FIG. 25A.

In exemplary embodiments, the device 100, 100a, 100b checks, for example by means of the processing apparatus 130 (FIG. 7), e.g. a message ID of the protocol data units I-PDU1, I-PDU2, I-PDU3, for example to ascertain a connection identifier VB-ID possibly associated with the message ID MSG-ID, see also e.g. FIG. 8.

In exemplary embodiments, the device 100, 100a, 100b checks, for example by means of the checking apparatus 125 (FIG. 1, 7), and e.g. on the basis of the e.g. previous check of the message ID MSG-ID, e.g. a length of the relevant protocol data unit I-PDU1, I-PDU2, I-PDU3.

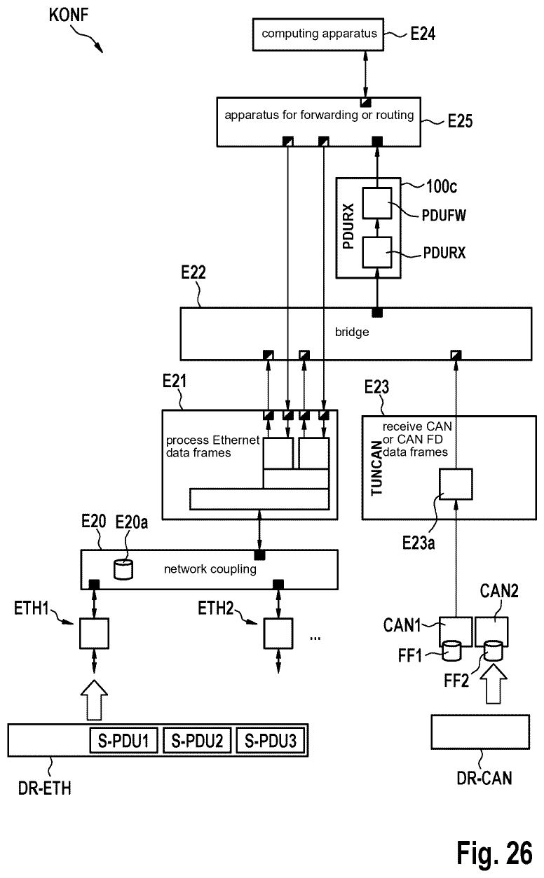

FIG. 26 schematically shows a simplified block diagram according to exemplary embodiments. An exemplary configuration CONF is shown, comprising a device 100c that, in further exemplary embodiments, for example has a functionality similar or identical to at least one of the devices 100, 100a, 100b described above by way of example.

Element E20 symbolizes a network coupling element, for example a bridge, for example an IEEE 802.1 Q-compatible bridge, which is designed to receive, from at least one Ethernet interface ETH1, ETH2, . . . , data, e.g. in the form of Ethernet data frames DR-ETH, and to forward received data, e.g. to the apparatus E21.

In further exemplary embodiments, the network coupling element E20 has an apparatus E20a that is designed to perform the ascertainment 1302 according to FIG. 24A (e.g. the ascertainment of a UDP socket), for example by means of a TCAM lookup. The result of the ascertainment 1302 (e.g. an ascertained UDP socket) can be sent to the apparatus E21, for example, in further exemplary embodiments.

In further exemplary embodiments, the apparatus E21 is designed to process, for example, Ethernet data frames DR-ETH received from the bridge E20, for example to extract protocol data units S-PDU1, S-PDU2, S-PDU3 contained in the received Ethernet data frames DR-ETH from a received Ethernet data frame DR-ETH, and, optionally, to assign the extracted protocol data units S-PDU1, S-PDU2, S-PDU3 to the UDP socket ascertained, for example, by means of the TCAM E20a, for example by concatenating an item of information characterizing the ascertained UDP socket with the relevant protocol data unit S-PDU1, S-PDU2, S-PDU3.

Element E22 symbolizes a bridge, e.g. for processing or distributing protocol data units, e.g. L-PDUs. The bridge E22 can, for example, receive protocol data units S-PDU1, S-PDU2, S-PDU3 from the apparatus E21 and forward them to the device 100c, e.g. for at least one check according to exemplary embodiments.

In further exemplary embodiments, the bridge E22 can, for example, also receive protocol data units I-PDU1, I-PDU2, I-PDU3 e.g. associated with at least one CAN interface or CAN FD interface CAN1, CAN2 from an apparatus E23 and forward them to the device 100c, e.g. for at least one check according to exemplary embodiments. For example, the bridge E22 therefore forwards multiple protocol data units, e.g. of different types or origins (blocks E21, E23), e.g. in a serialized, i.e. chronologically consecutive, manner to the device 100c.

In further exemplary embodiments, the apparatus E23 is designed to receive CAN or CAN FD data frames DR-CAN from the at least one CAN interface or CAN FD interface CAN1, CAN2 and to process them, for example to ascertain a CAN socket ID, e.g. by means of a TCAM apparatus E23a. In further exemplary embodiments, the apparatus E23 is designed to output received CAN or CAN FD data frames DR-CAN, possibly together with an ascertained CAN socket ID, to the bridge E22.

In further exemplary embodiments, the at least one CAN interface or CAN FD interface CAN1, CAN2 can have at least one filter apparatus FF1, FF2 for data frames, e.g. a frame filter, by means of which, for example, CAN data frames arriving at the relevant CAN interface CAN1, CAN2 can be filtered according to predeterminable criteria (e.g. according to one or more criteria).

In further exemplary embodiments, the device 100c is designed to check the protocol data units received from the bridge E22, e.g. of I-PDU type or of S-PDU type (or of another type or PDU type), e.g. on the basis of the principle according to the embodiments, e.g. according to one or more predeterminable rules. Preferably, the check by the device 100c is carried out in a hardware-based manner, for example a purely hardware-based, manner, i.e. without the use of software, for example, which allows a particularly efficient check and provides security against software-based attempted attacks.

Optionally, in further exemplary embodiments, the device 100c can supply one or more protocol data units, possibly after a check by the device 100c, to a software-based further check, e.g. by a computing apparatus E24, e.g. via an apparatus E25 for processing, for example forwarding or routing, protocol data units. Through the preceding, e.g. purely hardware-based, check of protocol data units by means of the device 100c, the computing apparatus E24 can be advantageously relieved, e.g. with regard to checking protocol data units, in further exemplary embodiments.

In further exemplary embodiments, a check of e.g. S-PDUS, e.g. S-PDUs transmitted via CAN FD, is also possible by the device 100, 100a, 100b, 100c.

In further exemplary embodiments, an item of information indicating the CAN bus of possibly multiple CAN buses at which a CAN message or CAN FD message has arrived can be assigned, for example added, to one or more protocol data units contained in the CAN message or CAN FD message, e.g. by concatenating the item of information with the protocol data unit. In other exemplary embodiments, this also allows e.g. a check, e.g. a deep packet inspection, of SOME/IP messages, e.g. via CAN or CAN FD.

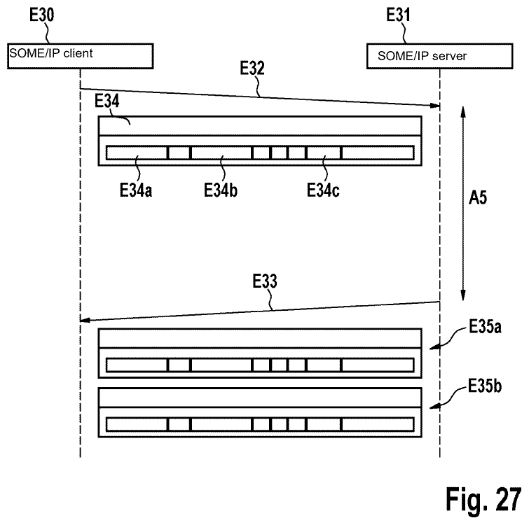

FIG. 27 schematically shows a simplified signal diagram according to exemplary embodiments. Element E30 symbolizes a SOME/IP client, element E31 symbolizes a SOME/IP server. Element E32 symbolizes a SOME/IP request from the client E30 to the server E31, and element E33 symbolizes a SOME/IP response from the server E31 to the client E30. The double arrow A5 symbolizes a predeterminable maximum waiting time within which, e.g. the response E33 to the request E32 must be made in order to still be considered valid in some embodiments.

In further exemplary embodiments, the client E30 sets a message ID E34a of a protocol data unit E34 associated with the request E32, for example on the basis of a SOME/IP method that the client E30 wants to invoke. Optionally, the client E30 can set the request ID E34b to a predeterminable, e.g. unique, value, e.g. to differentiate the request E32 from other requests. For example, the client E30 sets the message type E34c to “REQUEST.”

After receiving the request E32 or the protocol data unit E34 associated therewith, the server E31 uses the same message ID and the same request ID as in the request E32 and sets the message type of a protocol data unit that can be used for the response E33 to a) “RESPONSE,” according to a first option, see the protocol data unit E35a, or to b) “ERROR,” according to a second option, see the protocol data unit E35b.

In further exemplary embodiments, the principle according to the embodiments can be used e.g. for providing a firewall, e.g. a hardware-based firewall, e.g. a state-based (e.g. stateful) firewall, for protocol data units E34, E35a, E35b associated with the SOME/IP protocol.

For example, in further exemplary embodiments, for example, the checking apparatus 125 can be designed to check 1210 (FIG. 2D), for example in the state-based check 12b (FIG. 2A), whether a) a response message RESP-MSG, see also the response E33 according to FIG. 27, has been received after the sending of a request message E32, for example associated with the response message E33, and/or whether b) a received response message RESP-MSG E33 is associated with a previously sent request message E32, and/or whether c) a received response message E33 has been received within a predeterminable response time A5 in relation to the sending of a request message E32 associated with the response message E33.

In further exemplary embodiments, the response time A5 is, for example, configurable, and a response message E33 arriving after the expiration of the response time A5 in relation to the previous reception of a request message E32 associated therewith, is, for example, discarded as faulty or invalid.

Further exemplary embodiments, FIG. 21, relate to a device for carrying out the method according to the embodiments. In further exemplary embodiments, the device can, for example, have at least one of the configurations 100, 100a, 100b, 100c, CONF already described above by way of example with reference to FIGS. 1, 7, 18 and 26.

In further exemplary embodiments, the device can alternatively or additionally also have the configuration 300 shown by way of example in FIG. 21 or a configuration similar thereto.

The device 300 has: a computing apparatus (“computer”) 302 having at least one computing core 302a, 302b, 302c, a memory apparatus 304, associated with the computing apparatus 302, for at least temporarily storing at least one of the following elements: a) data DAT, b) computer program PRG, in particular for performing the method according to the embodiments. In further exemplary embodiments, for example, a computing core 302c can also be designed or modified in such a way that it realizes the function of the firewall or, as an alternative to a further computing core, the device 300 can have a hardware circuit 302c that realizes the firewall 125 and, in further embodiments (not shown), can also be provided outside the computing apparatus 302. This applies similarly to the hardware component 132 in further exemplary embodiments.

The optional elements 325, 332 according to FIG. 21 each symbolize, by way of example, a hardware firewall 325 or hardware component 332, e.g. comparable to the components 132, 125.

In further exemplary embodiments, the memory apparatus 304 has a volatile memory (e.g. working memory (RAM)) 304a, and/or a non-volatile memory (e.g. flash EEPROM) 304b, or a combination thereof or with other types of memory not explicitly mentioned.

In further exemplary embodiments, the data DAT can at least temporarily have at least one received protocol data unit PDU-1 and/or at least a portion of at least one search tree B-1, B-2, and/or associated information, for example color information characterizing red-black attributes of the second search tree B-2, and/or state information, e.g. for the state-based check 12b (FIG. 2A).

In further exemplary embodiments, at least one of the buffer memories E5, E6, E8 according to FIG. 18 can be realized, for example, by means of the memory apparatus 304 or the RAM 304a.

In further exemplary embodiments, the device 300 has at least one data interface 306 for receiving and/or transmitting data, for example protocol data units. In further exemplary embodiments, at least some of the input interfaces 110 (FIG. 1) and/or of the output interfaces 120 can be realized by means of the data interface 306, for example.

Further exemplary embodiments relate to a computer-readable storage medium SM comprising instructions that, when executed by a computer 302, cause the latter to perform the method according to the embodiments.

Further preferred embodiments relate to a computer program PRG comprising instructions that, when the program PRG is executed by a computer 302, cause the latter to perform the method according to the embodiments.

Further exemplary embodiments relate to a data carrier signal DCS that characterizes and/or transmits the computer program PRG according to the embodiments. For example, the data carrier signal DCS can be transmitted via the data interface 306 of the device 300.

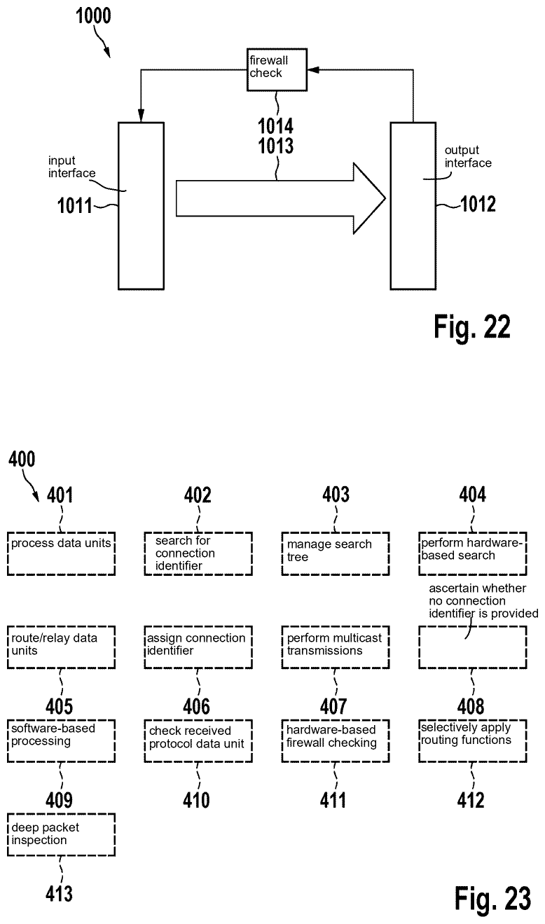

In further exemplary embodiments, the device 100, 100a, 100b, 100c, 300 can be used, for example, for or in an automotive gateway 1000, FIG. 22, i.e., a gateway for applications in the field of automotive engineering, wherein, for example, a check 12, 12a, 12b can be carried out, for example by means of hardware, for protocol data units PDU-1 arriving at the device, and/or wherein optionally, for example a relevant connection identifier VB-ID-1 can be ascertained, for example by means of hardware, for protocol data units PDU-1 arriving at the device, and wherein optionally, for example, the incoming protocol data units PDU-1 can be output on the basis of the ascertained connection identifier VB-ID-1. Advantageously, a hardware firewall 125 can subject at least some of the incoming protocol data units PDU-1 to a hardware-based security check, which can be e.g. non-state-based (cf. block 12a according to FIG. 2A) and/or state-based (cf. block 12b according to FIG. 2A).

In further exemplary embodiments, the input interfaces 110 and/or the output interfaces 120 can, for example, in each case also have at least one virtual interface, for example in contrast to a physical interface.

In further exemplary embodiments, a virtual interface can be characterized in that individual data units, for example protocol data units, for example as a so-called “contained PDU,” are present, for example, in an Ethernet or UDP packet, for example a so-called “container PDU.” In further exemplary embodiments, the contained PDUs can be extracted from the container PDU, for example by means of a packet parser.

In further exemplary embodiments, a common data format or message format, e.g. for processing incoming protocol data units PDU-1, can be used by the device according to the embodiments, for example independently of a relevant type (for example, L-PDUs, I-PDUs, N-PDUs, S-PDUs) of the incoming protocol data units PDU-1, with an efficient hardware-based firewall check being possible at the same time.

In further exemplary embodiments, the received protocol data units PDU-1, for example on the basis of the search 200 (FIG. 9) or the ascertainment 202, are provided with a connection identifier VB-ID-1, which is, for example, independent of the protocol or of a relevant type (for example, L-PDUs, I-PDUs, N-PDUs, S-PDUs) of the incoming protocol data units PDU-1 and on the basis of which, for example, a firewall check 12, 12a, 12b (e.g. hardware-based) (and optionally possibly software-based by means of the optional computing apparatus E24, FIG. 26) and/or possibly routing, for example forwarding, of the protocol data units PDU-1 can be performed by the device or in the device, e.g. to one or more (multicast) output interfaces.

In further exemplary embodiments, a modification of the PDU identifier PDU-ID can be selectively performed.

In further exemplary embodiments, unknown protocol data units (for which the search 200 or the ascertainment 202 was e.g. negative and thus did not lead to a connection identifier associated with the PDU identifier PDU-ID) can be processed further, for example by means of the software component 134, for example by a computer program that can be provided for this purpose and performs e.g. a detailed analysis of the unknown protocol data unit or a security analysis, and/or by means of the firewall 125.

In further exemplary embodiments, the device 100, 100a, 100b, 100c, 300 according to the embodiments can be used, for example, as a, e.g. unidirectional, feedback apparatus for a gateway, for example for an automotive gateway 1000, cf. FIG. 22, wherein, for example, the device 100, 100a, 100b, 100c, 300 is designed to receive protocol data units PDU-1 from at least one output interface 1012 of the gateway 10 and optionally to supply the protocol data units PDU-1 to at least one input interface 1011 of the gateway 10. Advantageously, the device 100, 100a, 100b, 100c, 300 can perform the above-described firewall check 12, 12a, 12b for at least some protocol data units PDU-1. For example, the block 1014 in FIG. 22 can have the configuration 100, 100a, 100b, 100c, 300 according to the embodiments described above by way of example. The block arrow 1013 symbolizes a data flow in the gateway 1000, for example from the input interface 1011 to the output interface 1012, such as is associated with a processing pipeline of the gateway 1010, for example.

In further exemplary embodiments, the device 100, 100a, 100b, 100c, 300 is designed to receive data units, for example complete data units, e.g. protocol data units, for example sequentially in time (“serialized”), for example from a component of the at least one output interface 1012 of the gateway 1000.

In further exemplary embodiments, the device 100, 100a, 100b, 100c, 300 is designed to output protocol data units to be output, in the same format as they have been received. In further exemplary embodiments, the device 100, 100a, 100b, 100c, 300 is designed to insert a connection identifier ascertained e.g. on the basis of the search 200, into a received protocol data unit PDU-1. In further exemplary embodiments, the device 100, 100a, 100b, 100c, 300 is designed to insert a (e.g. set) firewall flag (fw, see above), e.g. on the basis of an ascertained connection identifier, into a received protocol data unit PDU-1, whereby in further exemplary embodiments it can be communicated to the firewall 125 that it is to carry out a check of the relevant protocol data unit PDU-1.

In further exemplary embodiments, the device 100, 100a, 100b, 100c, 300 is designed to change a type, e.g. a message type, of a received protocol data unit PDU-1.

In further exemplary embodiments, the device 100, 100a, 100b, 100c, 300 is designed to change, for example correct, a length of a received protocol data unit PDU-1, for example in the case of received padded data units associated with CAN FD data frames, for example. In further exemplary embodiments, this can be useful, for example, if the received protocol data unit PDU-1 is to be forwarded to another output interface (e.g. of the CAN-FD type), for example with its actual length (and not e.g. the length caused by the padding).

In further exemplary embodiments, the device 100, 100a, 100b, 100c, 300 is designed to load a table associated with the at least one search tree B-1, B-2 or characterizing the at least one search tree B-1, B-2, for example to load it dynamically, i.e. during an operation of the device, wherein the loaded data DAT can be stored, for example at least temporarily, in the memory apparatus 304. In further exemplary embodiments, for example, the second search tree B-2 can thus be loaded into the device, for example externally, and at a predeterminable point in time, for example when the device is reset, the content of the second search tree B-2 can be transmitted to the first search tree B-1 so that, from then on, the first search tree B-1 can be used with the new content based on the loaded second search tree B-2, for example for the hardware-based search 200.

In further exemplary embodiments, the device 100, 100a, 100b, 100c, 300 can selectively use, for example, a search tree B-1 or a first search tree B-1 and a second search tree B-2 or corresponding tables, wherein, for example, in some exemplary embodiments, a memory region available for the search tree(s) or the corresponding tables can be used for a search tree B-1 or a table, wherein, for example, in further exemplary embodiments, the memory region available for the search tree(s) or the corresponding tables can be used for both search trees B-1, B-2 or corresponding tables so that e.g. in the case of two search trees, approximately half the storage capacity results for in each case one search tree, compared to the case of a single search tree B-1.

In further exemplary embodiments, the first buffer memory E5 (FIG. 18) can be used, e.g. for a rate adaptation, i.e., for example, for an adaptation of a rate at which received protocol data units PDU-1 are output via at least one output interface 120a of the second number of output interfaces 120 and/or at which received protocol data units PDU-1 are checked by means of the firewall 125, possibly before the optional output. In further exemplary embodiments, the rate can be controlled 261 or regulated 262, for example (FIG. 17).

In further exemplary embodiments, both a rate at which protocol data units are received from the gateway 1000 or its output interface 1012 and a rate at which protocol data units are transmitted to the gateway 1000 or its input interface 1012 can be predetermined e.g. by the processing pipeline 14.

In further exemplary embodiments, the device 100, 100a, 100b, 100c, 300 is designed to receive incoming protocol data units, for example in the form of “bursts,” i.e. intermittently, and/or to check them by means of the firewall 125.

In further exemplary embodiments, the search apparatus E1 is designed to operate at a non-constant rate with respect to a processing (e.g. search) because, for example, individual searches 200 for different received protocol data units, e.g. in the first search tree B-1, can take different amounts of time, for example.

In further exemplary embodiments, an optional security check 12 or a security check that can be selectively activated or carried out for individual protocol data units, for example by a firewall apparatus 125, E10, can also lead to a non-constant processing rate for protocol data units.

In further exemplary embodiments, such a possibly non-constant processing rate can be at least partially compensated or adjusted to a predeterminable rate, for example by using at least one of the buffer memories E5, E6, E8.

In further exemplary embodiments, the first buffer memory E5 is designed to output an item of status information a6 e.g. to a component 1012 of the gateway 1000 providing the protocol data units PDU-1, which e.g. indicates that a first fill level of the first buffer memory E5, e.g. a configurable fill level, has been reached. In further exemplary embodiments, the first buffer memory E5 is designed to no longer output the item of status information a6, e.g. if the, e.g. configurable, first fill level (or a predeterminable second fill level, which can be different from the first fill level, e.g. for achieving a hysteresis) of the first buffer memory E5 is undershot again.

In further exemplary embodiments, data units, for example protocol data units, reach the device 100 or the checking apparatus 125, E10, for example firewall apparatus 125, E10, via different link layers (for example connection levels), some of which are listed below by way of example:

Case 1: Ethernet and/or IP/UDP Container:

Here, protocol data units are multiplexed into user datagram protocol, UDP, container packets, for example.

### Case 2: CAN Container:

Here, protocol data units are multiplexed into a CAN container data frame (“frame”), for example.

### Case 3: CAN/LIN Bus:

Here, a received CAN or LIN data frame, e.g. frame, carries, for example exactly, one protocol data unit.

In further exemplary embodiments, for example in the above-mentioned case 1 and/or 2, the checking apparatus 125, E10 can be designed to carry out a check 12, 12a, 12b on at least one of the layers 2 to 4 of the ISO/OSI reference model (e.g. “layer 2-4 firewall”).

In further exemplary embodiments, for example in the above-mentioned case 1 and/or 2, at least one frame filter, e.g. filter for data frames, can be provided, for example a layer 2 frame filter, which, for example only, considers or checks or filters the container.

In further exemplary embodiments, the function of the filter for data frames, for example layer 2 frame filter, can be realized by the checking apparatus 125, E10. In further exemplary embodiments, the function of the filter for data frames, for example layer 2 frame filter, can also be realized by at least one component other than the checking apparatus 125, E10.

In further exemplary embodiments, the checking apparatus 125, E10 checks, for example only, the “contained” PDUs, i.e. the protocol data units contained in the relevant container.

In further exemplary embodiments, the layer 2-4 firewalls/frame filters and a layer 5 firewall function, such as can be realized by the checking apparatus 125, E10, are linked, whereby in further exemplary embodiments e.g. an effective deep packet inspection can be realized.

In further exemplary embodiments, for example, the layer 2 (or layer 2-4) firewalls generate a first identifier, for example a so-called TCAMID, for example as a result of the L2 lookup for the container, i.e., for example, on the basis of a check of a container on the protocol layer 2.

In further exemplary embodiments, the first identifier, e.g. TCAMID, is inherited for example by all contained PDUs located in a relevant container, for example copied into the PDU header.

In further exemplary embodiments, the layer 5 firewall function, as can be realized by the checking apparatus 125, E10, for example, can link its, e.g. local, checking result (for layer 5, “L5”) with the result of the L2-L4 firewall, for example.

In further exemplary embodiments, the process described above by way of example can be used to carry out e.g. a deep packet inspection from layer 2 to layer 5.

For the case 2 of a CAN container described above by way of example, in which protocol data units are multiplexed into a CAN container data frame (“frame”), for example, a frame filter, which evaluates or checks CAN IDs, for example, can be provided in further exemplary embodiments.

For the case 1 mentioned above by way of example (Ethernet and/or IP/UDP container), a ternary content addressable memory (TCAM), which evaluates packet contents of at least one of the layers 2 to L4 can be used, for example, in further exemplary embodiments.

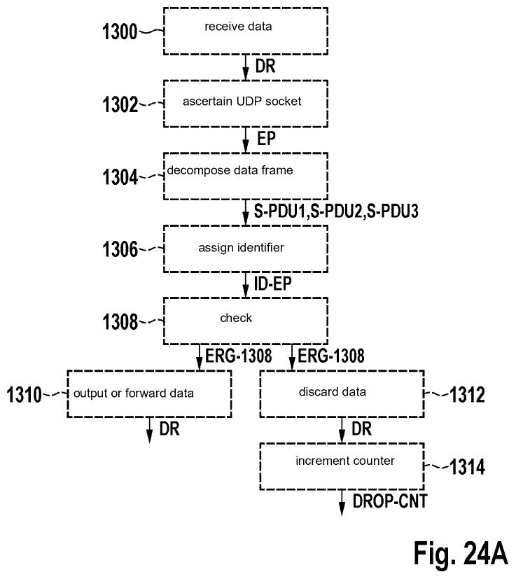

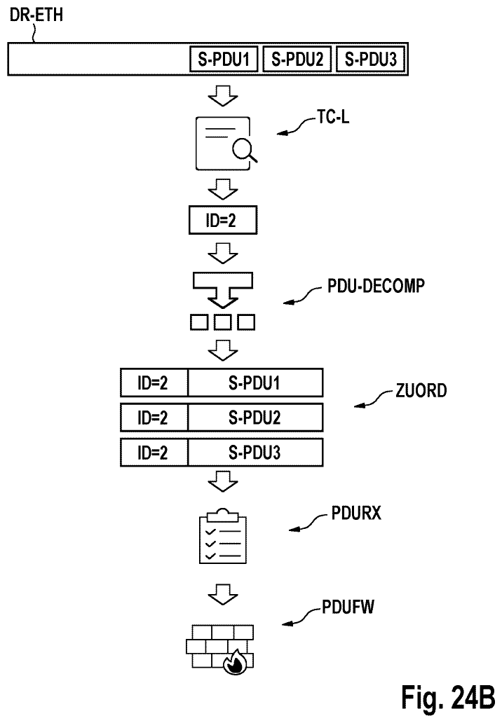

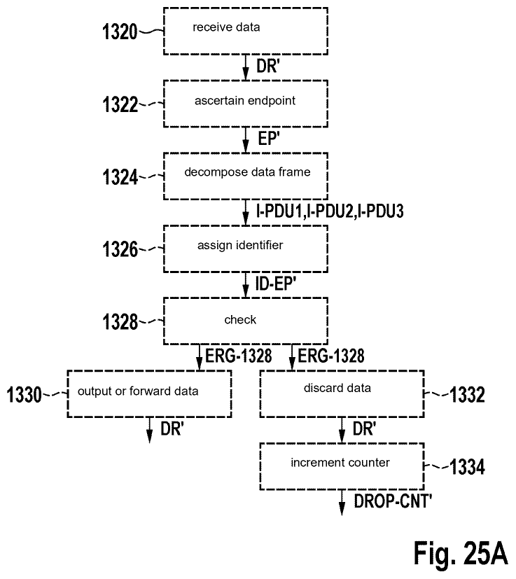

Further exemplary embodiments, FIG. 23, relate to the use 400 of the device according to the embodiments and/or of the method according to the embodiments and/or of the computer-readable storage medium according to the embodiments and/or of the computer program according to the embodiments and/or of the data carrier signal according to the embodiments and/or of the gateway according to the embodiments for at least one of the following elements: a) processing 401 of data units, for example protocol data units, for example of a vehicle, for example of a motor vehicle, b) ascertaining 402, for example searching, for example by means of a hardware component, for a connection identifier associated with a received protocol data unit, c) managing 403 at least one search tree, d) performing 404 a hardware-based search for a connection identifier for a data unit, for example protocol data unit, for example of a gateway for automotive applications, wherein, for example, the search can be performed with logarithmic effort, e) routing 405 or relaying data units, for example protocol data units, for example of a vehicle, for example of a motor vehicle, wherein for example the data units can be of different types, f) assigning 406 a connection identifier, for example a protocol-independent connection identifier, g) performing 407 multicast transmissions, h) ascertaining 408 whether no connection identifier is provided, for example stored, for example contained in the search tree, for a predeterminable received data unit, for example protocol data unit, i) software-based processing 409 of a received data unit, for example protocol data unit, for which no connection identifier is provided, for example stored, for example contained in the search tree, j) checking 410 the at least one received protocol data unit PDU-1, for example performing 12 a security check, k) hardware-based firewall checking 411 of protocol data units that are associated with at least one protocol, for example at least one service-oriented protocol that runs on layer 5 of the ISO/OSI reference model, for example protocol data units associated with a Scalable Service-Oriented Middleware over IP, SOME/IP, protocol, l) selectively applying 412 routing functions, for example forwarding functions, and/or firewall functions to protocol data units, m) checking 413, e.g. deep packet inspection, of SOME/IP messages, e.g. via CAN or CAN FD.

1-26. (canceled)

27. A device for processing protocol data units, comprising:
a first number of input interfaces configured to receive protocol data units; and
a checking apparatus configured to check at least one received protocol data unit including to subject the at least one received protocol data unit to a security check, wherein the checking apparatus to at least occasionally carry out at least one of the following checks: a) a non-state-based check with respect to the at least one received protocol data unit, b) a state-based check with respect to the at least one received protocol data unit.

28. The device according to claim 27, further comprising:
a second number of output interfaces configured to output protocol data units.

29. The device according to claim 27, wherein the checking apparatus is a pure hardware circuit.

30. The device according to claim 27, wherein the checking apparatus is configured to selectively check the at least one received protocol data unit based on a first item of control information including a bit flag.

31. The device according to claim 27, wherein the checking apparatus is configured to check all the received protocol data units.

32. The device according to claim 27, wherein the checking apparatus is configured to subject at least some received protocol data units to the non-state-based check, and, based on a result of the non-state-based check, to subject at least some of the received protocol data units to the state-based check.

33. The device according to claim 27, wherein the checking apparatus is configured to check protocol data units that are associated with at least one service-oriented protocol that operates on layer 5 of an ISO/OSI reference model.

34. The device according to claim 27, wherein the checking apparatus is configured to check at least one of the following elements of header data of a protocol data unit associated with the SOME/IP protocol, during the non-state-based check: a) a message identifier, b) a service identifier, c) a method ID, d) a length, e) a request identifier, f) a client identifier, g) a session identifier, h) a protocol version, i) an interface version, j) a message type, k) a return value.

35. The device according to claim 27, wherein the checking apparatus is configured to, in the state-based check, check: a) whether a response message has been received after a sending of a request message, and/or b) whether a received response message is associated with a previously sent request message, and/or c) whether a received response message has been received within a predeterminable response time in relation to a sending of a request message associated with the response message.

36. The device according to claim 27, wherein the checking apparatus is configured to discard or not to discard the at least one received protocol data unit based on the check.

37. The device according to claim 27, wherein the checking apparatus is configured to modify or influence: (i) the at least one received protocol data unit and/or (ii) an output of the at least one received protocol data unit via an output interface.

38. The device according to claim 27, wherein the checking apparatus is configured to carry out at least one of the following elements: a) attack detection, b) marking the at least one received protocol data unit based on the check and/or based on a result of the check, c) outputting and/or forwarding the at least one received protocol data unit using a multicast mechanism, d) outputting and/or forwarding the at least one received protocol data unit by a unicast mechanism, e) ascertaining and/or evaluating messages for service discovery, f) ascertaining and/or evaluating protocol data units of a AUTOSAR l-PDU type.

39. The device according to claim 27, further comprising at least one memory for at least temporarily storing: (i) one or more protocol data units, or (ii) parts of one or more protocol data units.

40. The device according to claim 27, further comprising a conditioning apparatus which is configured to change a PDU identifier associated with the at least one received protocol data unit.

41. The device according to claim 27, wherein the checking apparatus is configured to use a connection identifier associated with the at least one received protocol data unit for ascertaining a service associated with the at least one received protocol data unit.

42. A computer-implemented method for processing protocol data units, for a device having a first number of input interfaces for receiving protocol data units, and a checking apparatus configured to check at least one received protocol data unit, the method comprising the following steps:
receiving at least one protocol data unit;
checking the at least one received protocol data unit using the checking apparatus, wherein the checking apparatus at least occasionally carries out at least one of the following checks: a) a non-state-based check with respect to the at least one received protocol data unit, b) a state-based check with respect to the at least one received protocol data unit.

43. The method according to claim 42, further comprising at least one of the following elements: a) outputting the at least one protocol data unit based on the check, b) discarding the at least one protocol data unit based on the check.

44. The method according to claim 42, wherein the checking apparatus subjects at least some received protocol data units to the non-state-based check, and, based of a result of the non-state-based check, subjects at least some of the received protocol data units to the state-based check.

45. The method according to claim 42, wherein the checking apparatus carries out at least one of the following elements: a) attack detection, b) marking the at least one received protocol data unit based on the check and/or based on a result of the check, c) outputting and/or forwarding the at least one received protocol data unit by a multicast mechanism, d) outputting and/or forwarding the at least one received protocol data unit by a unicast mechanism, e) ascertaining and/or evaluating messages for service discovery, f) ascertaining and/or evaluating protocol data units of a AUTOSAR l-PDU type.

46. The method according to claim 42, further comprising at least one of the following elements: a) receiving data in a form of a data frame, b) ascertaining an endpoint associated with the reception of the data, c) breaking down the data frame into at least one protocol data unit, d) assigning an identifier characterizing the endpoint to the at least one protocol data unit, e) checking at least one of the following elements of the at least one protocol data unit: e1) message identifier, e2) request identifier, e3) protocol version, e4) interface version, e5) message type, f) based on the check, f1) outputting or forwarding the data, or f2a) discarding the data and/or f2b) incrementing a counter.

47. The method according to claim 42, further comprising at least one of the following elements: a) receiving data in a form of a data frame, b) ascertaining an endpoint associated with the reception of the data, c) breaking down the data frame into at least one protocol data unit, d) assigning an identifier characterizing the endpoint to the at least one protocol data unit, e) checking at least one of the following elements of the at least one protocol data unit: e1) message identifier, e2) length, f) based on the check: f1) outputting or forwarding the data, or f2a) discarding the data and/or f2b) incrementing a counter.

48. A non-transitory computer-readable storage medium on which is stored a computer program including instructions for processing protocol data units, for a device having a first number of input interfaces for receiving protocol data units, and a checking apparatus configured to check at least one received protocol data unit, the instructions, when executed by a computer, causing the computer to perform the following steps:
receiving at least one protocol data unit;
checking the at least one received protocol data unit using the checking apparatus, wherein the checking apparatus at least occasionally carries out at least one of the following checks: a) a non-state-based check with respect to the at least one received protocol data unit, b) a state-based check with respect to the at least one received protocol data unit.

49. An automotive gateway, comprising:
at least one device for processing protocol data units, including
a first number of input interfaces configured to receive protocol data units, and
a checking apparatus configured to check at least one received protocol data unit including to subject the at least one received protocol data unit to a security check, wherein the checking apparatus to at least occasionally carry out at least one of the following checks: a) a non-state-based check with respect to the at least one received protocol data unit, b) a state-based check with respect to the at least one received protocol data unit.

50. The device according to claim 27, wherein the device is used for at least one of the following elements: a) processing protocol data units of a motor vehicle, b) ascertaining, using a hardware component, a connection identifier associated with a received protocol data unit, c) managing at least one search tree, d) performing a hardware-based search for a connection identifier, for a protocol data unit, of a gateway for an automotive applications, e) routing or relaying protocol data units of a motor vehicle, wherein the protocol data units can be of different types, f) assigning a protocol-independent connection identifier, g) performing multicast transmissions, h) ascertaining whether no connection identifier is provided, i) software-based processing of a protocol data unit for which no connection identifier is provided, j) checking the at least one received protocol data unit including performing a security check, k) hardware-based firewall checking of protocol data units that are associated with at least one protocol, l) selectively applying routing functions to protocol data units, m) deep packet inspection of SOME/IP messages via CAN or CAN FD.
